(19) United States
(12) Patent Application Publication
(10) Pub. No.: US 2020/0348978 A1
(43) Pub. Date: Nov. 5, 2020

(54) METHODS AND SYSTEMS THAT CORRELATE RESOURCE IDENTIFIERS AMONG MANAGEMENT SERVICES AND APPLICATIONS

(71) Applicant: VMware, Inc, Palo Alto, CA (US)

(72) Inventor: Nicholas Mark Grant Stephen, Paris (FR)

(73) Assignee: VMware, Inc., Palo Alto, CA (US)

(21) Appl. No.: 16/400,393

(22) Filed: May 1, 2019

(51) Int. Cl. G06F 9/50; G06F 9/48; G06F 9/455; H04L 9/08

(52) U.S. Cl. CPC G06F 9/5027; G06F 9/5072; G06F 9/541; G06F 9/45558; H04L 9/0866; G06F 9/4881

(57) ABSTRACT

The current document is directed to a resource-identifier-correlation service and/or application that maintains correlation information about the different resource identifiers used by different management applications and/or services within a cloud-computing facility or distributed cloud-computing facility. In one implementation, the resource-identifier-correlation service and/or application continuously monitors streams of inventory/configuration data for different management applications and/or services in order to construct and maintain a database of computational resources and the resource identifiers associated with the computational resources. The resource-identifier-correlation service and/or application includes one or both of a service interface and an application programming interface (“API”) that provide many different functionalities related to identifying and monitoring correlations between resource identifiers used by the different management applications and/or services.

### TECHNICAL FIELD

The current document is directed to distributed computing systems and, in particular, to methods and systems that correlate different resource identifiers used by different management applications and/or services for the same computational resource to facilitate concurrent use of the management applications, including to facilitate query execution across the multiple management applications and/or services.

### BACKGROUND

Computer systems and computational technologies have steadily evolved, during the past 70 years, from initial vacuum-tube-based systems that lacked operating systems, compilers, network connectivity, and most other common features of modern computing systems to vast distributed computing systems that include large numbers of multi-processor servers, data-storage appliances, and multiple layers of internal communications networks interconnected by various types of wide-area networks and that provide computational resources to hundreds, thousands, tens of thousands, or more remote users. As operating systems, and virtualization layers have been developed and refined, over the years, in parallel with the advancements in computer hardware and networking, the robust execution environments provided by distributed operating systems and virtualization layers now provide a foundation for development and evolution of many different types of distributed application programs, including distributed database-management systems, distributed client-server applications, and distributed web-based service-provision applications. This has resulted in a geometric increase in the complexity of distributed computing systems, as a result of which owners, administrators, and users of distributed computing systems and consumers of computational resources provided by distributed computing systems increasingly rely on automated and semi-automated management and computational-resource-distribution subsystems to organize the activities of many users and computational-resource consumers and to control access to, and use of, computational resources within distributed computing systems.

One problem domain that has emerged in the area of distributed computing systems is that many different types of management services and management applications have been developed for managing cloud-computing facilities and distributed cloud-computing facilities. Each of these different management services and management applications may provide different functionalities and different views of the various computational resources within the cloud-computing facility that they monitor and manage. As a result, efforts have been made to standardize the user interfaces and application-programming interfaces (“APIs”) provided by the various different management services and management applications. However, such efforts involve significant development efforts and fail to keep pace with the frequent emergence of new management services and management applications. Developers of cloud-computing management and administration services and application and managers and administrators of cloud-computing facilities continue to seek methods and systems for simplifying and aggregating the many different management services and management applications that may be used within a given cloud-computing facility or distributed cloud-computing facility.

### SUMMARY

The current document is directed to a resource-identifier-correlation service and/or application that maintains correlation information about the different resource identifiers used by different management applications and/or services within a cloud-computing facility or distributed cloud-computing facility. In one implementation, the resource-identifier-correlation service and/or application continuously monitors streams of inventory/configuration data for different management applications and/or services in order to construct and maintain a database of computational resources and the resource identifiers associated with the computational resources. The resource-identifier-correlation service and/or application includes one or both of a service interface and an application programming interface (“API”) that provide many different functionalities related to identifying and monitoring correlations between resource identifiers used by the different management applications and/or services.

### BRIEF DESCRIPTION OF THE DRAWINGS

FIG. 1 provides a general architectural diagram for various types of computers.

FIG. 2 illustrates an Internet-connected distributed computing system.

FIG. 3 illustrates cloud computing.

FIG. 4 illustrates generalized hardware and software components of a general-purpose computer system, such as a general-purpose computer system having an architecture similar to that shown in FIG. 1.

FIGS. 5A-D illustrate two types of virtual machine and virtual-machine execution environments.

FIG. 6 illustrates an OVF package.

FIG. 7 illustrates virtual data centers provided as an abstraction of underlying physical-data-center hardware components.

FIG. 8 illustrates virtual-machine components of a VI-management-server and physical servers of a physical data center above which a virtual-data-center interface is provided by the VI-management-server.

FIG. 9 illustrates a cloud-director level of abstraction.

FIG. 10 illustrates virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds.

FIG. 11 illustrates the multiple-management-service-and/or-application problem domain to which the currently disclosed methods and systems are directed.

FIG. 12 illustrates a universal query adapter that has been developed to provide a universal query interface to multiple management services and/or applications.

FIG. 13 illustrates an example of the operation of the universal query adapter discussed with reference to FIG. 12.

FIG. 14 illustrates certain of the problems associated with resource identifiers.

FIGS. 15A-C illustrate augmented identifiers that constitute natural keys.

FIGS. 16A-B illustrate one implementation of the currently disclosed resource-identifier-correlation service and/or application.

FIG. 17 illustrates five relational-database tables used to illustrate one implementation of the current disclosed resource-identifier-correlation service and/or application.

FIGS. 18A-F provide control-flow diagrams that illustrate operation of the currently disclosed resource-identifier-correlation service.

FIGS. 19A-F provide control-flow diagrams for the new-data handler, called in step 1810 of FIG. 18A, that handles change messages received from the management-application configuration/inventory service, as discussed with reference to FIG. 16A.

### DETAILED DESCRIPTION

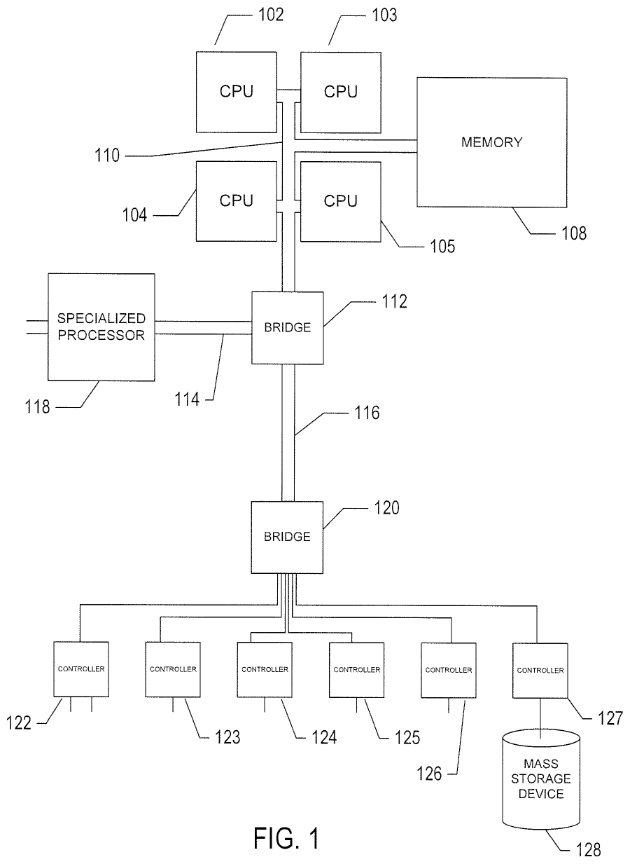

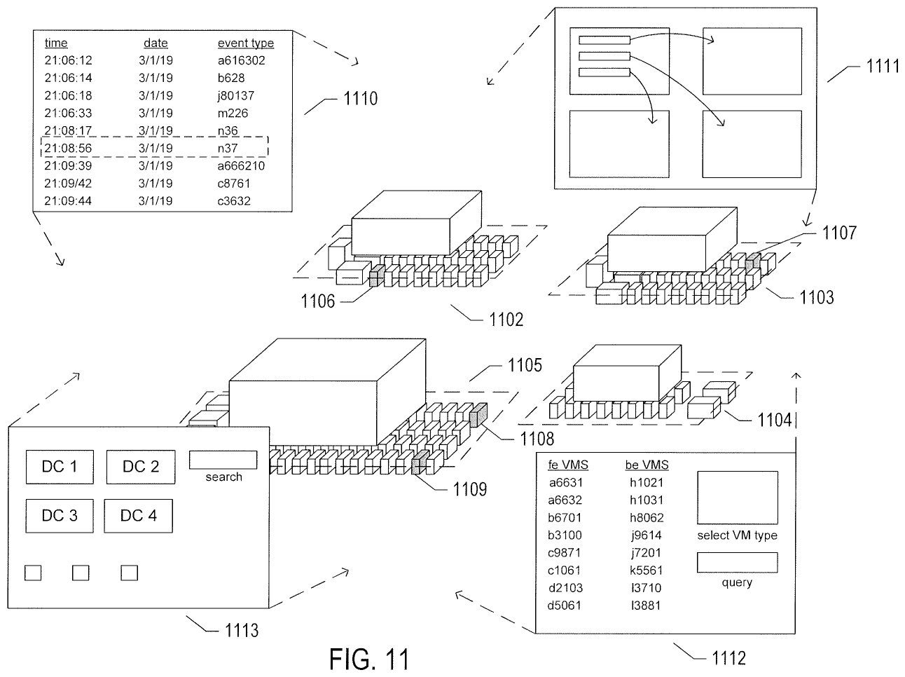

The current document is directed to a resource-identifier-correlation service and/or application that maintains correlation information about the different resource identifiers used by different management applications and/or services. In a first subsection, below, a detailed description of computer hardware, complex computational systems, and virtualization is provided with reference to FIGS. 1-10. In a second subsection, the methods and systems to which the current document is directed are discussed with reference to FIGS. 11-19E.

### Computer Hardware, Complex Computational Systems, and Virtualization

The term “abstraction” is not, in any way, intended to mean or suggest an abstract idea or concept. Computational abstractions are tangible, physical interfaces that are implemented, ultimately, using physical computer hardware, data-storage devices, and communications systems. Instead, the teiui “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modern technology and science to misinterpret the terms “abstract” and “abstraction,” when used to describe certain aspects of modern computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices, no less essential and physical than a cam-shaft control system in an internal-combustion engine. Multi-cloud aggregations, cloud-computing services, virtual-machine containers and virtual machines, communications interfaces, and many of the other topics discussed below are tangible, physical components of physical, electro-optical-mechanical computer systems.

FIG. 1 provides a general architectural diagram for various types of computers. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

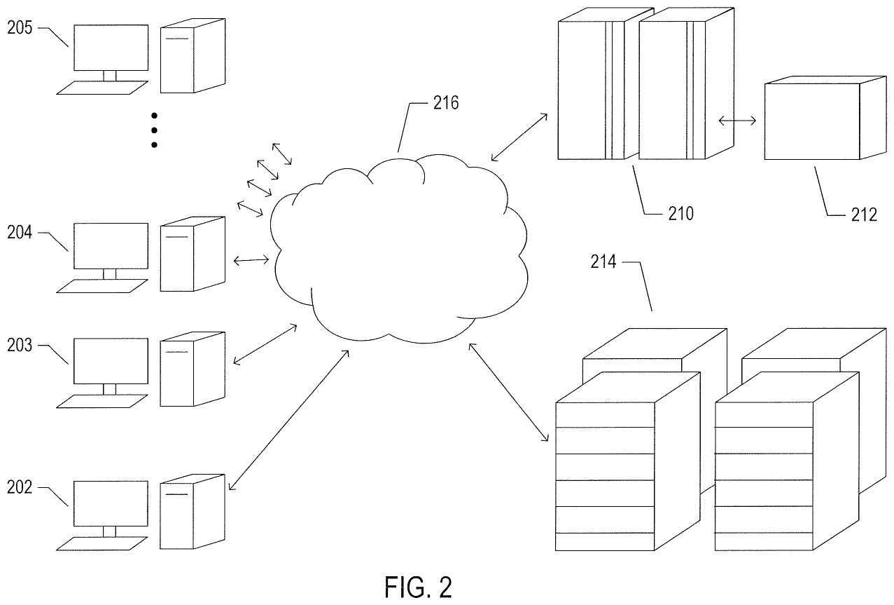

FIG. 2 illustrates an Internet-connected distributed computing system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computing systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

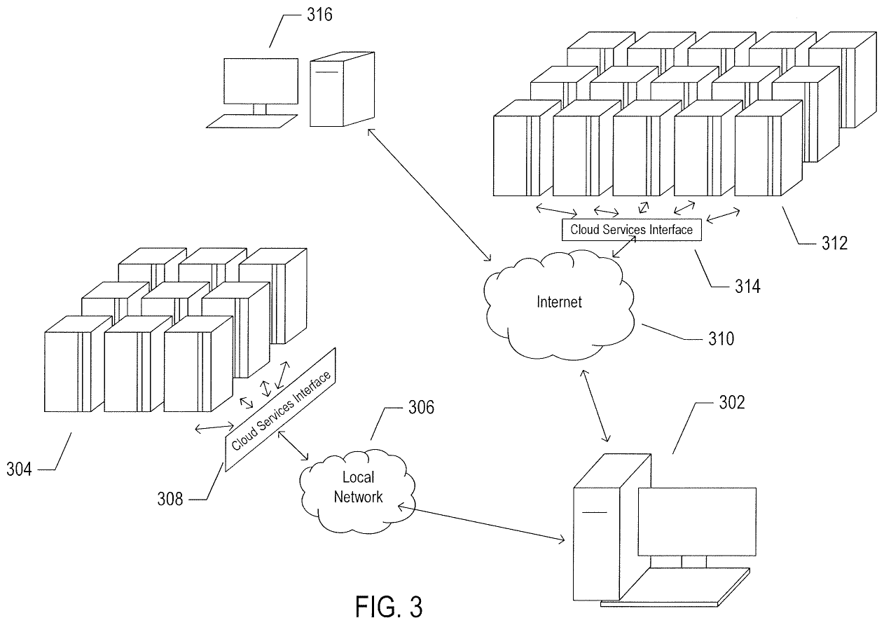

FIG. 3 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the resources to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

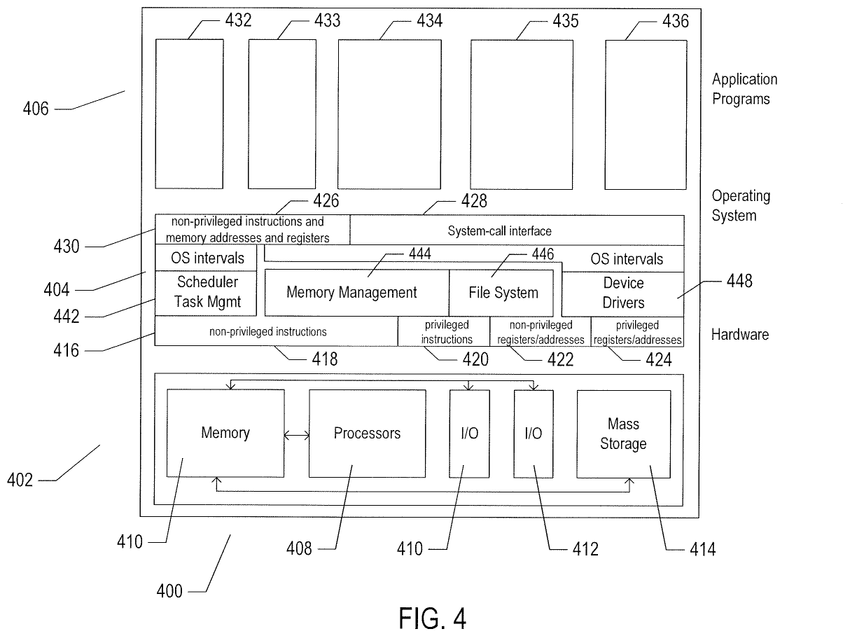

FIG. 4 illustrates generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 436 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computing system for high-availability, fault-tolerance, and load-balancing purposes. The problems are even greater in heterogeneous distributed computing systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

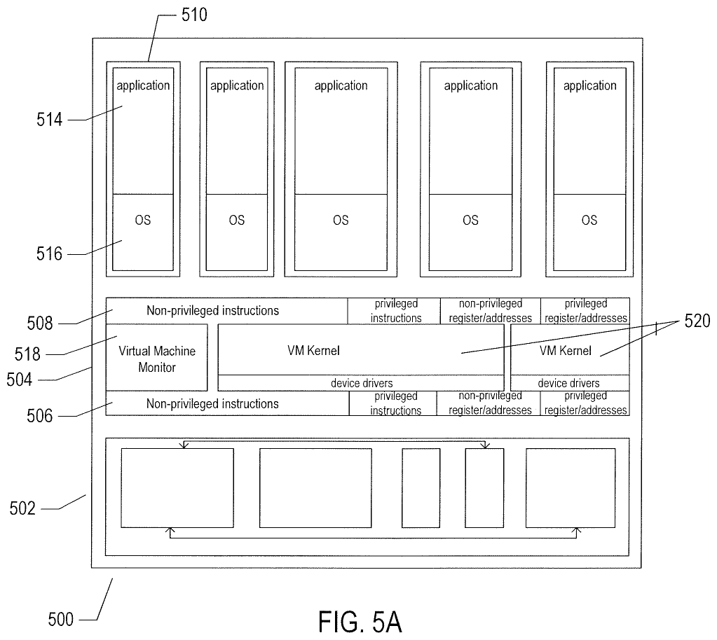

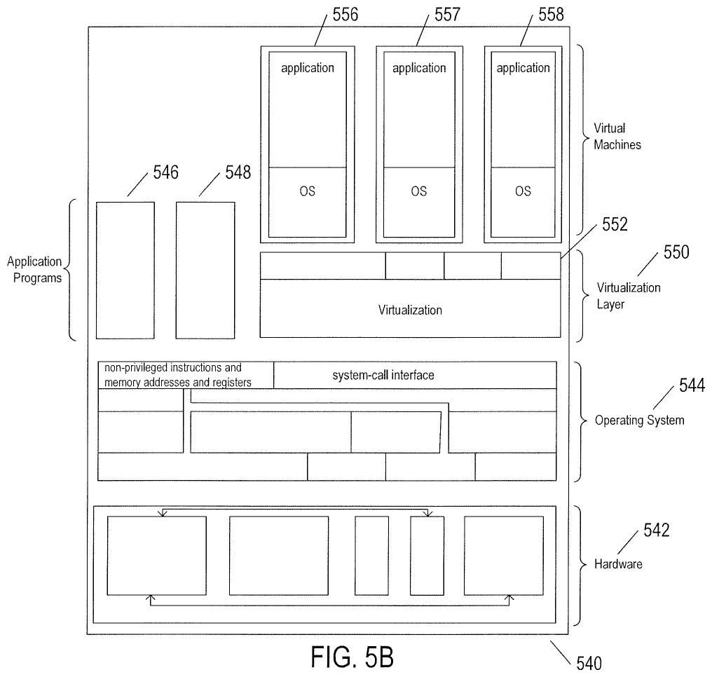

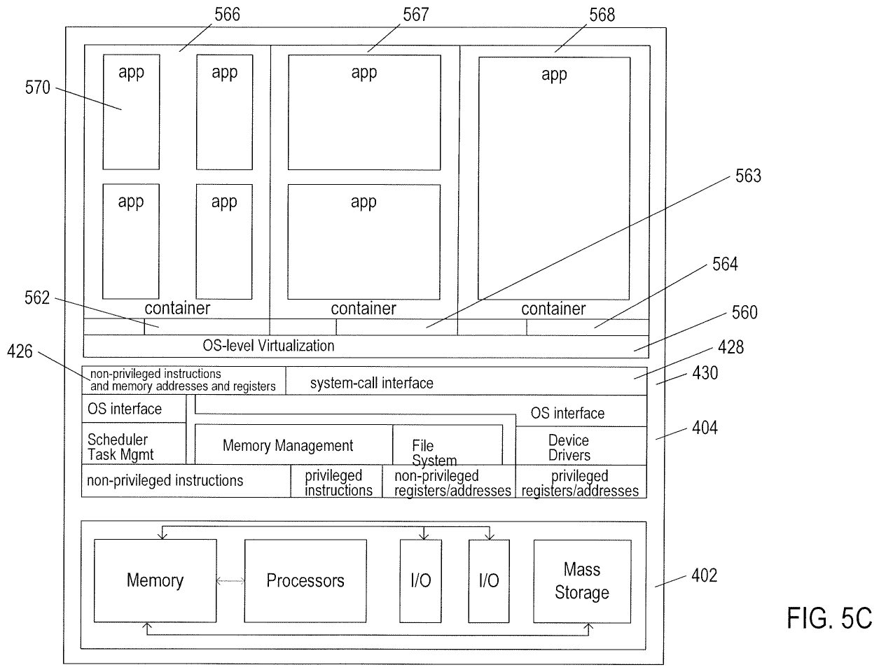

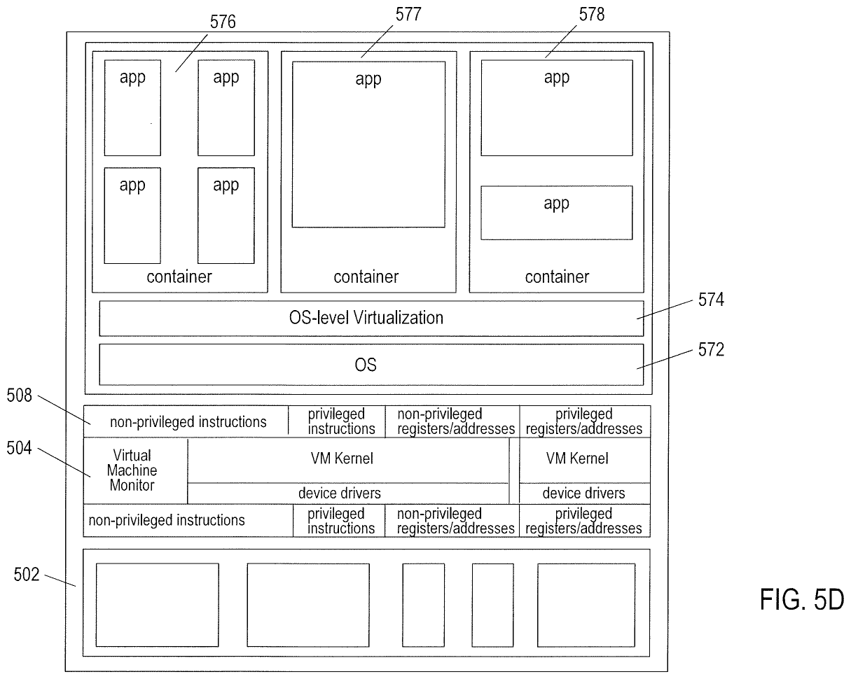

For all of these reasons, a higher level of abstraction, referred to as the “virtual machine,” has been developed and evolved to further abstract computer hardware in order to address many difficulties and challenges associated with traditional computing systems, including the compatibility issues discussed above. FIGS. 5A-D illustrate several types of virtual machine and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment illustrated in Figure SA features a virtualization layer 504 that interfaces through a virtualization-layer/hardware-layer interface 506, equivalent to interface 416 in FIG. 4, to the hardware. The virtualization layer provides a hardware-like interface 508 to a number of virtual machines, such as virtual machine 510, executing above the virtualization layer in a virtual-machine layer 512. Each virtual machine includes one or more application programs or other higher-level computational entities packaged together with an operating system, referred to as a “guest operating system,” such as application 514 and guest operating system 516 packaged together within virtual machine 510. Each virtual machine is thus equivalent to the operating-system layer 404 and application-program layer 406 in the general-purpose computer system shown in FIG. 4. Each guest operating system within a virtual machine interfaces to the virtualization-layer interface 508 rather than to the actual hardware interface 506. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 508 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes a virtual-machine-monitor module 518 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 508, the accesses result in execution of virtualization-layer code to simulate or emulate the privileged resources. The virtualization layer additionally includes a kernel module 520 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

FIG. 5B illustrates a second type of virtualization. In FIG. 5B, the computer system 540 includes the same hardware layer 542 and software layer 544 as the hardware layer 402 shown in FIG. 4. Several application programs 546 and 548 are shown miming in the execution environment provided by the operating system. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer/hardware-layer interface 552, equivalent to interface 416 in FIG. 4, provides an execution environment for a number of virtual machines 556-558, each including one or more application programs or other higher-level computational entities packaged together with a guest operating system.

While the traditional virtual-machine-based virtualization layers, described with reference to FIGS. 5A-B, have enjoyed widespread adoption and use in a variety of different environments, from personal computers to enormous distributed computing systems, traditional virtualization technologies are associated with computational overheads. While these computational overheads have been steadily decreased, over the years, and often represent ten percent or less of the total computational bandwidth consumed by an application running in a virtualized environment, traditional virtualization technologies nonetheless involve computational costs in return for the power and flexibility that they provide. Another approach to virtualization is referred to as operating-system-level virtualization (“OSL virtualization”). FIG. 5C illustrates the OSL-virtualization approach. In FIG. 5C, as in previously discussed FIG. 4, an operating system 404 runs above the hardware 402 of a host computer. The operating system provides an interface for higher-level computational entities, the interface including a system-call interface 428 and exposure to the non-privileged instructions and memory addresses and registers 426 of the hardware layer 402. However, unlike in FIG. 5A, rather than applications running directly above the operating system, OSL virtualization involves an OS-level virtualization layer 560 that provides an operating-system interface 562-564 to each of one or more containers 566-568. The containers, in turn, provide an execution environment for one or more applications, such as application 570 running within the execution environment provided by container 566. The container can be thought of as a partition of the resources generally available to higher-level computational entities through the operating system interface 430. While a traditional virtualization layer can simulate the hardware interface expected by any of many different operating systems, OSL virtualization essentially provides a secure partition of the execution environment provided by a particular operating system. As one example, OSL virtualization provides a file system to each container, but the file system provided to the container is essentially a view of a partition of the general file system provided by the underlying operating system. In essence, OSL virtualization uses operating-system features, such as name space support, to isolate each container from the remaining containers so that the applications executing within the execution environment provided by a container are isolated from applications executing within the execution environments provided by all other containers. As a result, a container can be booted up much faster than a virtual machine, since the container uses operating-system-kernel features that are already available within the host computer. Furthermore, the containers share computational bandwidth, memory, network bandwidth, and other computational resources provided by the operating system, without resource overhead allocated to virtual machines and virtualization layers. Again, however, OSL virtualization does not provide many desirable features of traditional virtualization. As mentioned above, OSL virtualization does not provide a way to run different types of operating systems for different groups of containers within the same host system, nor does OSL-virtualization provide for live migration of containers between host computers, as does traditional virtualization technologies.

FIG. 5D illustrates an approach to combining the power and flexibility of traditional virtualization with the advantages of OSL virtualization. FIG. 5D shows a host computer similar to that shown in FIG. 5A, discussed above. The host computer includes a hardware layer 502 and a virtualization layer 504 that provides a simulated hardware interface 508 to an operating system 572. Unlike in FIG. 5A, the operating system interfaces to an OSL-virtualization layer 574 that provides container execution environments 576-578 to multiple application programs. Running containers above a guest operating system within a virtualized host computer provides many of the advantages of traditional virtualization and OSL virtualization. Containers can be quickly booted in order to provide additional execution environments and associated resources to new applications. The resources available to the guest operating system are efficiently partitioned among the containers provided by the OSL-virtualization layer 574. Many of the powerful and flexible features of the traditional virtualization technology can be applied to containers running above guest operating systems including live migration from one host computer to another, various types of high-availability and distributed resource sharing, and other such features. Containers provide share-based allocation of computational resources to groups of applications with guaranteed isolation of applications in one container from applications in the remaining containers executing above a guest operating system. Moreover, resource allocation can be modified at run time between containers. The traditional virtualization layer provides flexible and easy scaling and a simple approach to operating-system upgrades and patches. Thus, the use of OSL virtualization above traditional virtualization, as illustrated in FIG. 5D, provides much of the advantages of both a traditional virtualization layer and the advantages of OSL virtualization. Note that, although only a single guest operating system and OSL virtualization layer as shown in FIG. 5D, a single virtualized host system can run multiple different guest operating systems within multiple virtual machines, each of which supports one or more containers.

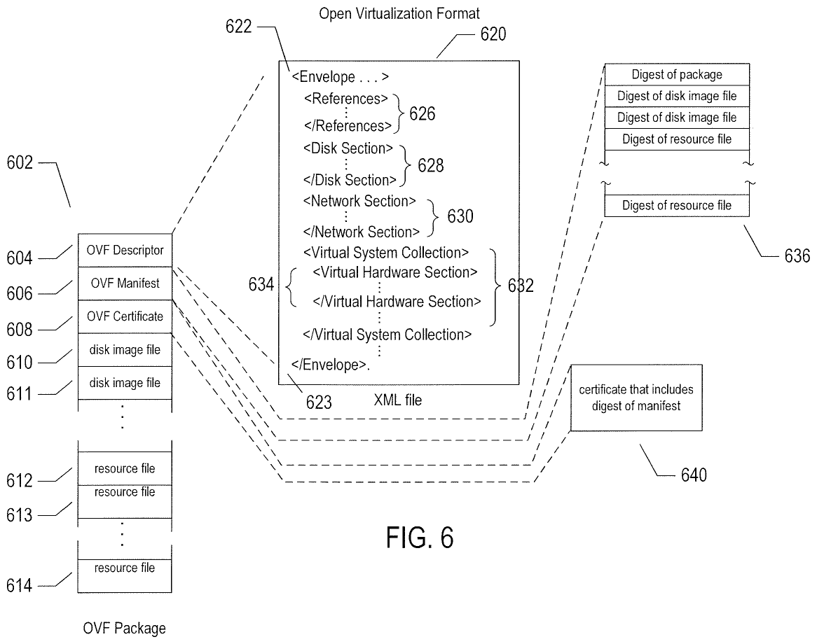

A virtual machine or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a virtual machine within one or more data files. FIG. 6 illustrates an OVF package. An OVF package 602 includes an OVF descriptor 604, an OVF manifest 606, an OVF certificate 608, one or more disk-image files 610-611, and one or more resource files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a networks section 630 that includes meta information about all of the logical networks included in the OVF package, and a collection of virtual-machine configurations 632 which further includes hardware descriptions of each virtual machine 634. There are many additional hierarchical levels and elements within a typical OVF descriptor. The OVF descriptor is thus a self-describing XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and resource files 612 are digitally encoded content, such as operating-system images. A virtual machine or a collection of virtual machines encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more virtual machines that is encoded within an OVF package.

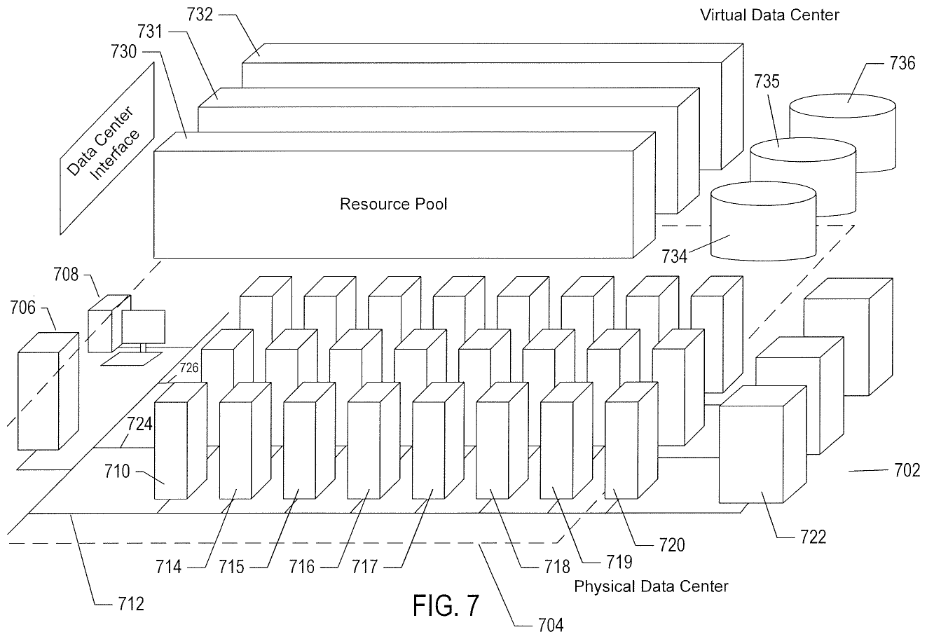

The advent of virtual machines and virtual environments has alleviated many of the difficulties and challenges associated with traditional general-purpose computing. Machine and operating-system dependencies can be significantly reduced or entirely eliminated by packaging applications and operating systems together as virtual machines and virtual appliances that execute within virtual environments provided by virtualization layers running on many different types of computer hardware. A next level of abstraction, referred to as virtual data centers which are one example of a broader virtual-infrastructure category, provide a data-center interface to virtual data centers computationally constructed within physical data centers. FIG. 7 illustrates virtual data centers provided as an abstraction of underlying physical-data-center hardware components. In FIG. 7, a physical data center 702 is shown below a virtual-interface plane 704. The physical data center consists of a virtual-infrastructure management server (“VI-management-server”) 706 and any of various different computers, such as PCs 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight servers and a mass-storage array. The individual server computers, such as server computer 710, each includes a virtualization layer and runs multiple virtual machines. Different physical data centers may include many different types of computers, networks, data-storage systems and devices connected according to many different types of connection topologies. The virtual-data-center abstraction layer 704, a logical abstraction layer shown by a plane in FIG. 7, abstracts the physical data center to a virtual data center comprising one or more resource pools, such as resource pools 730-732, one or more virtual data stores, such as virtual data stores 734-736, and one or more virtual networks. In certain implementations, the resource pools abstract banks of physical servers directly interconnected by a local area network.

The virtual-data-center management interface allows provisioning and launching of virtual machines with respect to resource pools, virtual data stores, and virtual networks, so that virtual-data-center administrators need not be concerned with the identities of physical-data-center components used to execute particular virtual machines. Furthermore, the VI-management-server includes functionality to migrate running virtual machines from one physical server to another in order to optimally or near optimally manage resource allocation, provide fault tolerance, and high availability by migrating virtual machines to most effectively utilize underlying physical hardware resources, to replace virtual machines disabled by physical hardware problems and failures, and to ensure that multiple virtual machines supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of virtual machines and virtual appliances as well as to provide high-level, distributed functionalities that involve pooling the resources of individual physical servers and migrating virtual machines among physical servers to achieve load balancing, fault tolerance, and high availability.

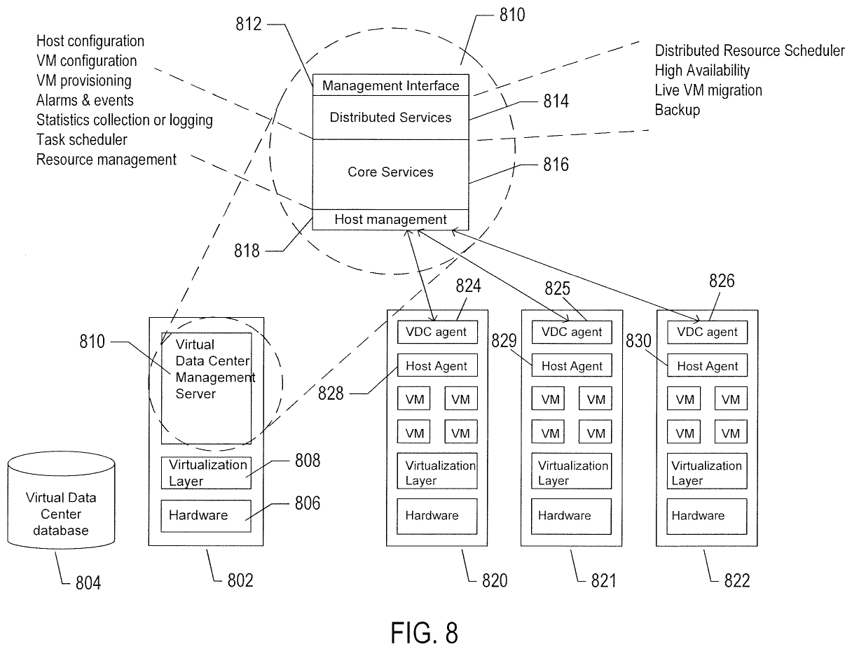

FIG. 8 illustrates virtual-machine components of a VI-management-server and physical servers of a physical data center above which a virtual-data-center interface is provided by the VI-management-server. The VI-management-server 802 and a virtual-data-center database 804 comprise the physical components of the management component of the virtual data center. The VI-management-server 802 includes a hardware layer 806 and virtualization layer 808 and runs a virtual-data-center management-server virtual machine 810 above the virtualization layer. Although shown as a single server in FIG. 8, the VI-management-server (“VI management server”) may include two or more physical server computers that support multiple VI-management-server virtual appliances. The virtual machine 810 includes a management-interface component 812, distributed services 814, core services 816, and a host-management interface 818. The management interface is accessed from any of various computers, such as the PC 708 shown in FIG. 7. The management interface allows the virtual-data-center administrator to configure a virtual data center, provision virtual machines, collect statistics and view log files for the virtual data center, and to carry out other, similar management tasks. The host-management interface 818 interfaces to virtual-data-center agents 824, 825, and 826 that execute as virtual machines within each of the physical servers of the physical data center that is abstracted to a virtual data center by the VI management server.

The distributed services 814 include a distributed-resource scheduler that assigns virtual machines to execute within particular physical servers and that migrates virtual machines in order to most effectively make use of computational bandwidths, data-storage capacities, and network capacities of the physical data center. The distributed services further include a high-availability service that replicates and migrates virtual machines in order to ensure that virtual machines continue to execute despite problems and failures experienced by physical hardware components. The distributed services also include a live-virtual-machine migration service that temporarily halts execution of a virtual machine, encapsulates the virtual machine in an OVF package, transmits the OVF package to a different physical server, and restarts the virtual machine on the different physical server from a virtual-machine state recorded when execution of the virtual machine was halted. The distributed services also include a distributed backup service that provides centralized virtual-machine backup and restore.

The core services provided by the VI management server include host configuration, virtual-machine configuration, virtual-machine provisioning, generation of virtual-data-center alarms and events, ongoing event logging and statistics collection, a task scheduler, and a resource-management module. Each physical server 820-822 also includes a host-agent virtual machine 828-830 through which the virtualization layer can be accessed via a virtual-infrastructure application programming interface (“API”). This interface allows a remote administrator or user to manage an individual server through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server. The virtual-data-center agents relay and enforce resource allocations made by the VI management server, relay virtual-machine provisioning and configuration-change commands to host agents, monitor and collect performance statistics, alarms, and events communicated to the virtual-data-center agents by the local host agents through the interface API, and to carry out other, similar virtual-data-management tasks.

The virtual-data-center abstraction provides a convenient and efficient level of abstraction for exposing the computational resources of a cloud-computing facility to cloud-computing-infrastructure users. A cloud-director management server exposes virtual resources of a cloud-computing facility to cloud-computing-infrastructure users. In addition, the cloud director introduces a multi-tenancy layer of abstraction, which partitions virtual data centers (“VDCs”) into tenant-associated VDCs that can each be allocated to a particular individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

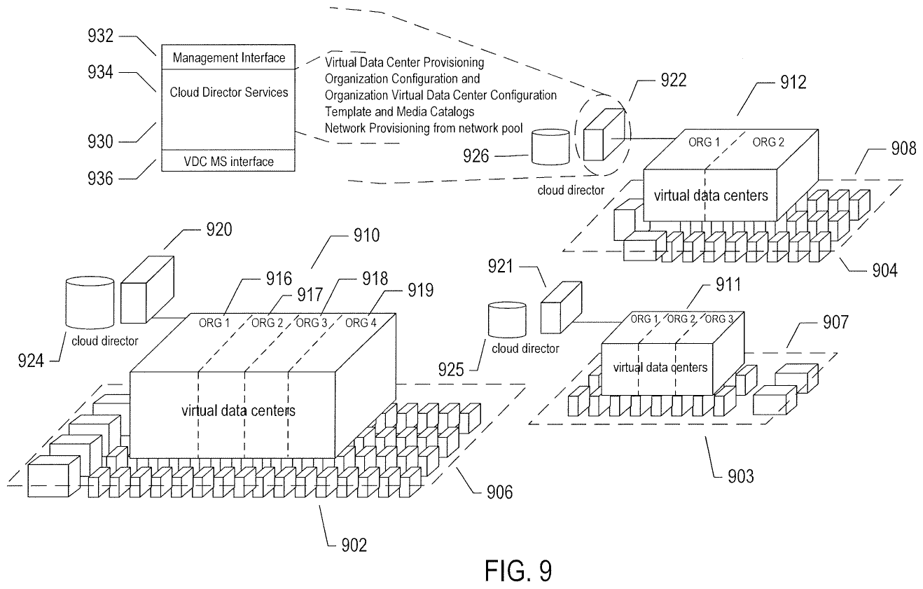

FIG. 9 illustrates a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The resources of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director servers 920-922 and associated cloud-director databases 924-926. Each cloud-director server or servers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are virtual machines that each contains an OS and/or one or more virtual machines containing applications. A template may include much of the detailed contents of virtual machines and virtual appliances that are encoded within OVF packages, so that the task of configuring a virtual machine or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VI management server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

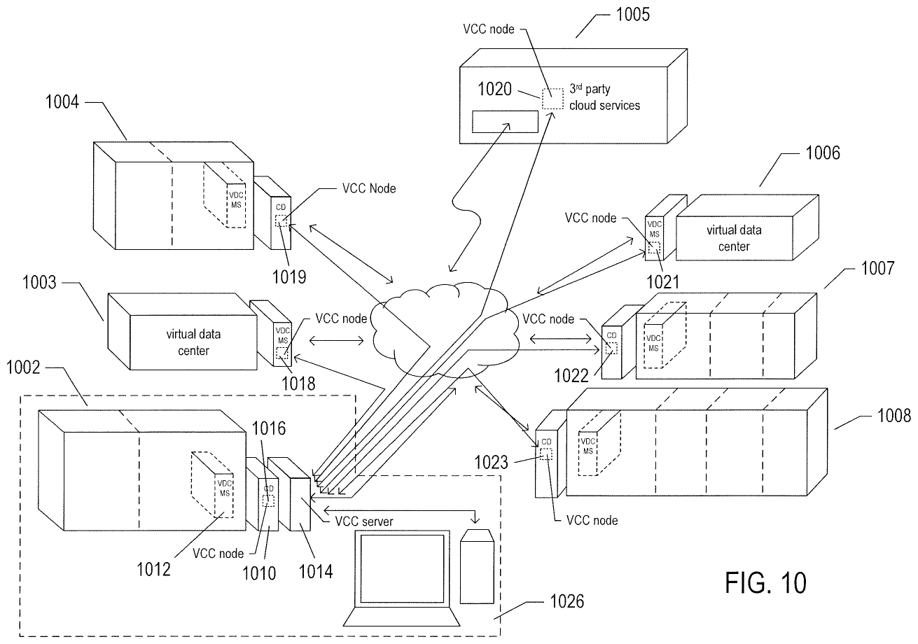

FIG. 10 illustrates virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of VCC server and nodes. In FIG. 10, seven different cloud-computing facilities are illustrated 1002-1008. Cloud-computing facility 1002 is a private multi-tenant cloud with a cloud director 1010 that interfaces to a VI management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VI management server that manages a single-tenant private cloud. The VCC server 1014 additionally interfaces, through the Internet, to VCC node virtual appliances executing within remote VI management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

### The Currently Disclosed Methods and Systems

FIG. 11 illustrates the multiple-management-service-and/or-application problem domain to which the currently disclosed methods and systems are directed. As shown in FIG. 11, a distributed cloud-computing facility that includes four data centers 1102-1105 additionally includes four different management servers and/or management applications running within servers 1106-1109 that provide four different sets of functionalities and user interfaces 1110-1113, respectively. Of course, a given management server or management application may run on multiple different servers and use additional appliances and computational resources. The phrase “management servers and/or management application” is used to indicate that cloud-computing-facility management can be implemented as a service or distributed service, which responds to client requests through a service interface, and/or as an application or distributed application that provides an API through which management functionalities are accessed by computational entities. In these various implementations, a user interface may additionally be provided, often by client-side portions of the management servers and/or management applications. The phrase “computational resource” refers to various different types of resources provided by computer systems, including processor cycles, a number of memory storage locations, a number of mass-storage units, communications-network bandwidth, virtual machines, and other such resources that may be viewed as services or operations provided by physical hardware components, services or operations provided by operating systems or virtualization layers, and services or operations provided by higher-level entities within computer systems.

The first management service or management application provides for log-file aggregation and features a service interface, user interface, and/or API 1110 with rich functionality for viewing and searching log files. The second management service or management application provides for sophisticated load balancing among the various data centers involving live migration of virtual machines among the various data centers and provides a service interface, user interface, and/or API 1111 with functionality for controlling and monitoring virtual-machine migration. The third management service or management application provides sophisticated configuration, administration, and management functionalities and provides a service interface, user interface, and/or API 1112 for querying configuration data and adjusting administration and management parameters. The fourth management service or management application provides similar functionality as provided by the third management service or management application, but provides a different set of functions and a very different service interface and user interface 1113. Examples of various types of management services and/or applications are discussed in the preceding subsection of this document. As mentioned above, the proliferation of different management services and/or applications with different service interfaces, user interfaces, and/or APIs has both provided a wealth of functionality and a variety of different types of information as well as large overheads associated with learning, developing to, and using the different service interfaces, user interfaces, and/or APIs and using the different management services and/or applications concurrently to manage a common set of computational facilities and computational resources.

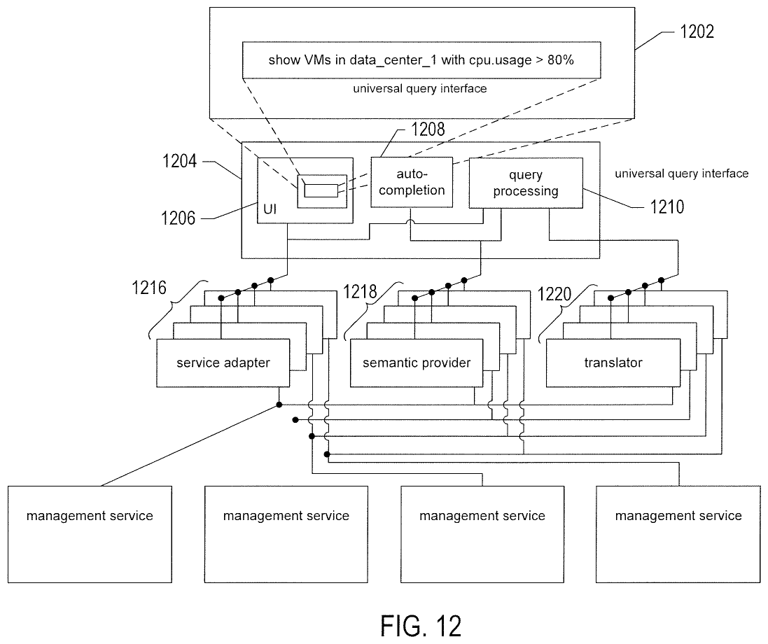

FIG. 12 illustrates a universal query adapter that has been developed to provide a universal query interface to multiple management services and/or applications. The universal query interface 1202 allows a user to construct and issue queries in a universal query language for execution across multiple different management services and/or applications. The universal query adapter 1204 is an application and/or service that includes the following three major modules with associated functionalities: (1) a user-interface module 1206 responsible for instantiating the universal query interface 1202 on remote computer systems and consoles; (2) an auto-completion module 1208 that is responsible for facilitating query construction by identifying a full noun or verb of the query language from initial characters input by a user and by either displaying the full noun or verb to eliminate a need for the user to type the remaining characters and/or by offering users various different possible choices for a noun or verb based on the initial characters input by a user and/or based on the local context of the query; and (3) a query processing module 1210 that optimizes universal queries and translates the queries into native queries that can be executed by one or more of the multiple different management services and/or applications. The above-mentions modules of the universal query adapter access intermediate modules developed to facilitate the adapter role of the universal query adapter with respect to the multiple management services and/or applications. Associated with each management service and/or application are three different intermediate modules: (1) a service adapter 1216 that provides functionality for submitting an optimized and translated universal query to the management service and/or application with which it is associated and provides functionality for returning the query response to the user-interface module for display and/or forwarding to a user or computational entity that accesses the universal query adapter through an API; (2) a semantic provider 1218 that provides semantic information about each noun and verb in a universal query, possible completions for nouns and verbs, and validation of query terms within their local contexts in the universal query; and (3) a translator 1220 that maps an expression tree generated by the universal query adapter for a universal query to the native query syntax expected by the associated management service and/or application. The intermediate modules 1216, 1218, and 1220 interface to the management services and/or applications to provide the various different management-services-and/or-applications functionalities needed by the universal query adapter.

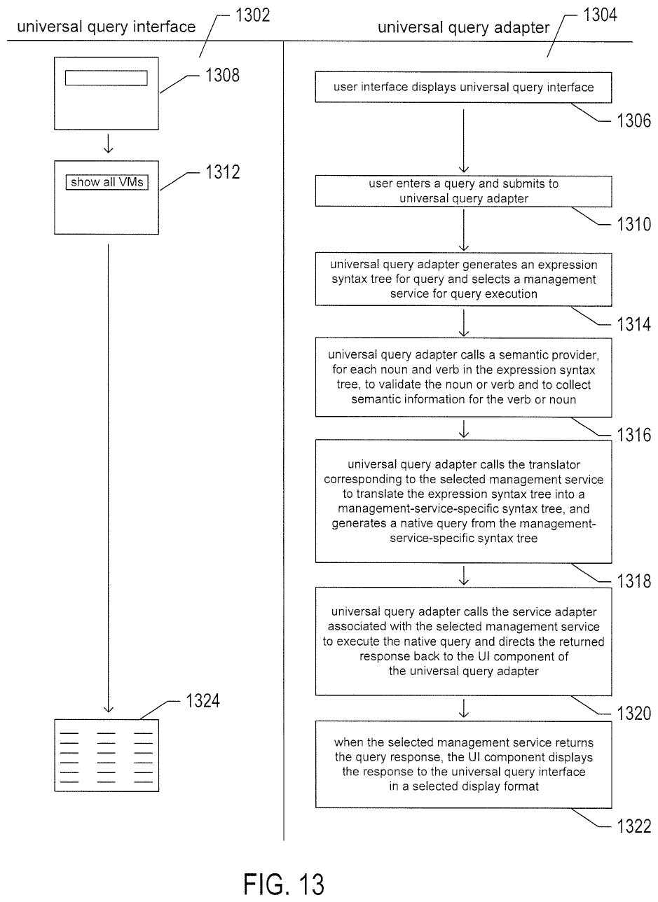

FIG. 13 illustrates an example of the operation of the universal query adapter discussed above with reference to FIG. 12. The left portion 1302 of FIG. 13 shows the representation of the universal query interface and a right portion 1304 of FIG. 13 shows a representation of the operations performed by the universal query adapter. In step 1306, the user interface module of the universal query adapter displays the universal query interface 1308. In step 1310, a user enters a query 1312 via the universal query interface and inputs a return or other indication for the universal query adapter to process the query. During this process, query completion may be provided by the universal query adapter via the above-mentioned semantic providers. In step 1314, the universal query adapter generates an expression syntax tree for the query and selects a management service or management application for query execution. In step 1316, the universal query adapter calls a semantic provider, for each noun and verb in the expression syntax tree, to validate the noun or verb and to collect semantic information for the verb or noun. In step 1318, the universal query adapter calls the translator intermediate module corresponding to the selected management service to translate the expression syntax tree into a management-service-specific syntax tree, and to then generate a native query from the management-service-specific syntax tree. In step 1320, the universal query adapter calls the service-adapter intermediate module associated with the selected management service or management application to execute the native query prepared in step 1318, directing the selected management service or management application to return a response to the query back to the user-interface component of the universal query adapter. In step 1322, the selected management service or management application returns a response to the query to the user-interface module which displays the response 1324 via the universal query interface. In more complex examples, the universal query adapter may select multiple management services and/or management applications for executing different portions of a complex universal query.

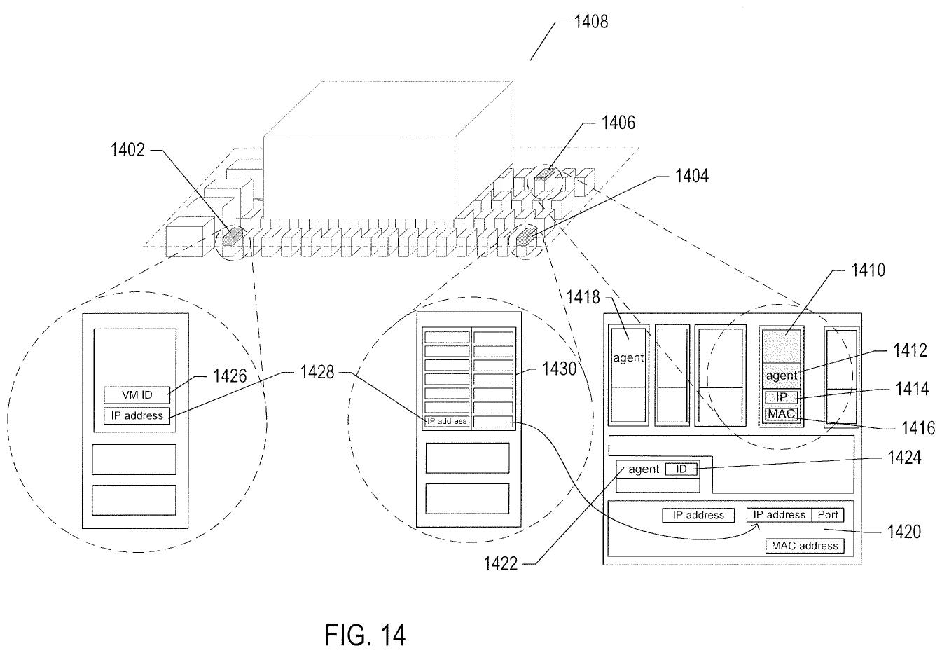

FIG. 14 illustrates certain of the problems associated with resource identifiers. As discussed above, each different management service and/or management application may employ different identifiers for a given computational resource, such as a virtual machine (“VM”), a network-attached storage device, a virtual network, virtual storage devices, physical computer systems, components of physical computer systems, physical networks, physical storage devices, application instances, network connection endpoints, and other such computational resources. In addition, different components of a cloud-computing facility may use different resource identifiers. In the example shown in FIG. 14, a management application runs on a first server 1402, a virtual-network bridge or router runs on a second server 1404, and a virtual machine runs within a third server 1406, all within a cloud-computing facility 1408. Different computational entities may use different types of identifiers to identify the virtual machine 1410 running within server 1406. A management-application agent 1412 that communicates with the management application running on the first server may run within the virtual machine along with one or more applications and may identify the virtual machine via a virtual IP address 1414 or virtual MAC address 1416 associated with the virtual machine. In alternative implementations, a management-application agent 1418 may run in a virtual machine different from virtual machine 1410 and may identify the virtual machine 1410 via an IP address and port number 1420 associated with server 1406 within which virtual machine 1410 runs. Other types of agents 1422 may run at levels below the virtualization layer within a server 1406 and may identify virtual machine 1406 using a unique identifier 1424 for the virtual machine maintained by the agent 1422. The management server may identify the virtual machine 1410 by a management-server-specific virtual-machine identifier 1426 and/or by an IP address 1428 that is translated by a virtual edge appliance via the network-address-translation table 1430 to the network address 1420 associated with server 1406. Thus, any given computational entity or computational resource within a cloud-computing facility, data center, or even standalone computer system may be associated with a variety of different types of identifiers, some of which are globally unique, others of which may be unique only within constrained, local computational environments, and still others of which may exhibit many-to-one relationships between multiple identifiers of one type and a single computational resource. As one example, certain IP addresses are globally unique while other IP addresses are unique only within a local network in which they are used, and a given server or virtual may be associated with multiple IP addresses.

Natural keys are identifiers that uniquely identify a computational resource within the distributed computing facility. These identifiers are established by entities and processes external to the currently disclosed resource-identifier-correlation service and/or application and external to the various different management services and/or applications within a distributed computer system. In certain implementations of the currently disclosed resource-identifier-correlation service and/or application, computational resources are considered to be uniquely identified, within a distributed cloud-computing facility, by strong natural keys, such as identifiers for virtual machines used by management services and management applications that execute within the distributed cloud-computing facility. For any given computational resource, there is only a single associated strong natural key of any given type of strong natural key. By contrast, computational resources are considered to be weakly identified within a distributed cloud-computing facility by weak natural keys, such as IP addresses. A given computational resource may be associated with multiple IP addresses, for example, and IP addresses may not be globally unique even within a particular cloud-computing facility, but may uniquely identify computational resources only within their respective local computing environments. Certain types of identifiers which, by themselves, do not uniquely identify a computational resource within a distributed computing facility, can be augmented with additional information so that the augmented identifiers do uniquely identify computational resources within a distributed computer facility and therefore constitute natural keys. Such augmented keys may be either strong natural keys or weak natural keys, depending on whether or not there is only a single augmented natural key of a particular type that identifies a particular computational resource.

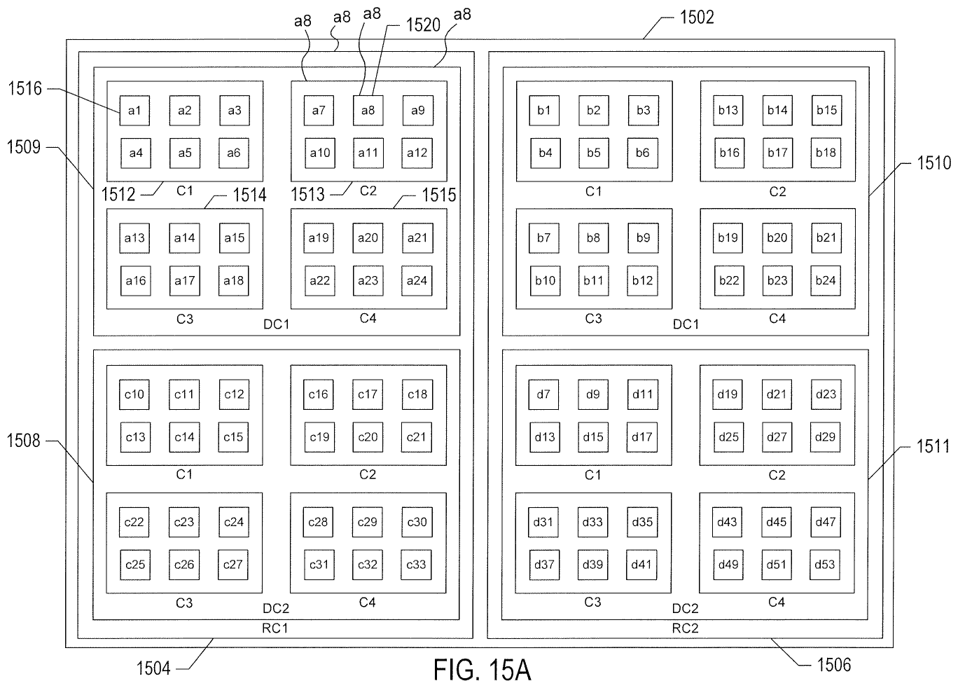

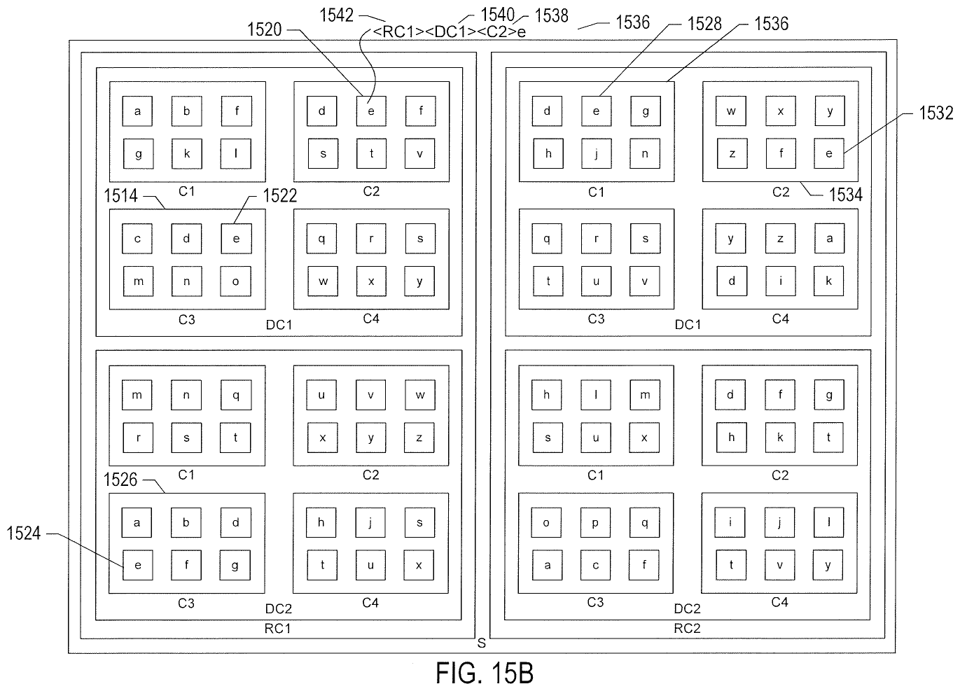

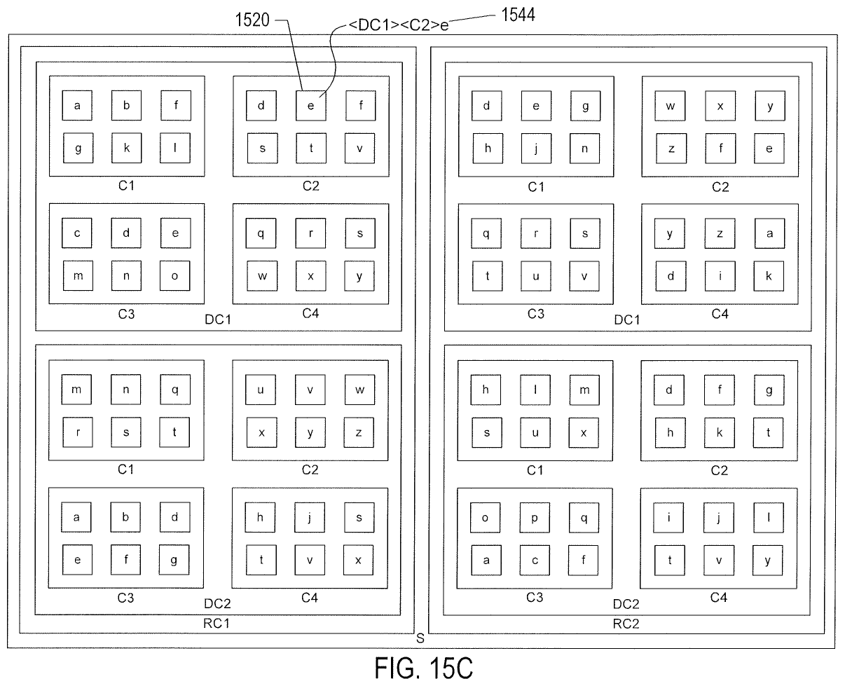

FIGS. 15A-C illustrate augmented identifiers that constitute natural keys. All of FIGS. 15A-C employ the same illustration conventions, next described with reference to FIG. 15A. In FIG. 15A, an outer rectangle 1502 represents a distributed cloud-computing facility. Two next-innermost rectangles 1504 and 1506, labeled “RC1” and “RC2,” represent two different organizations of components within the distributed cloud-computing facility, such as two different geographical regions. Four next-innermost rectangles 1508-1511, labeled “DC1,” “DC2,” “DC3,” and “DC4,” represent lower-level organizations of components, such as data centers. Each data center, such as data center 1509, includes four different computer systems, such as computer systems 1512-1515, labeled “C1,” “C2,” “C3,” and “C4” in data center 1509. Each computer system includes six computer-system components, such as computer-system component 1516, labeled “a1,” in computer system C1 (1512) within data center DC1 (1509) that is located within region RC1 (1504). In the example shown in FIG. 15A, the labels, or identifiers, associated with each computer-system component are globally unique. Therefore, the label or resource identifier “a8,” associated with computer-system component 1520, is a unique identifier for the system component 1520 within the distributed cloud-computing facility and, therefore, is a strong natural key for the system component. In addition, the identifier “a8” may also serve as a unique identifier for the computer system 1513 that includes the system component, the data center 1509 that includes this computer system, and the region 1504 that contains this data center. By contrast, in FIG. 15B, the labels, such as the label “e” for computer-system component 1520, are only unique within the computer system which contains the system component. For example, the same label “e” is used for computer-system component 1522 in computer system 1514, for computer-system component 1524 in computer system 1526, for computer-system component 1528 in computer system 1530, and for computer-system component 1532 in computer system 1534. The identifier “e” can be augmented, as indicated by the identifier 1536 at the top of FIG. 15B, with the identifiers of the containing computer system 1538, the containing data center 1540, and the containing region 1542 to produce a triply augmented identifier 1536 that uniquely identifies computer-system component 1520. Note that, without including the identifier 1542 for the region in the augmentation, the doubly augmented identifier would not uniquely identify computer-system component 1520, since computer-system component 1532 would also be identified by the doubly augmented identifier “<DC1><C2>e.” However, as shown in FIG. 15 C, when each data center has a unique label, or identifier, the doubly augmented identifier 1544 uniquely identifies computer-system component 1520. Thus, there are many possible argumentations that can be used to generate natural keys from non-unique identifiers.

One of the problems addressed by the currently disclosed resource-identifier-correlation service and/or application is the fact that different management services and/or applications running concurrently within a cloud-computing facility may use different identifiers for the same computational resource. In fact, as discussed above with reference to FIG. 14, even different entities within a distributed management service or management application may use different identifiers for the same computational resource. Identifiers for computational resources generated and used by management services and/or applications are referred to as “synthetic keys,” and represent an identifier space distinct from the identifier space corresponding to the above-discussed natural keys. In order to be able to provide for universal queries that can be executed across different management services and/or applications, the universal query adapter needs to be able to correlate the various different identifiers used by different management services and/or management applications to identify a particular computational resource commonly managed by the different management services and/or management applications. Moreover, these correlations need to be provided by an ongoing computational-resource-monitoring process or service, since the association of identifiers with computational resources can change, over time, and since computational resources may be added to or deleted from the cloud-computing facility. Furthermore, different entities may use different combinations of identifiers for identifying any particular computational resource.

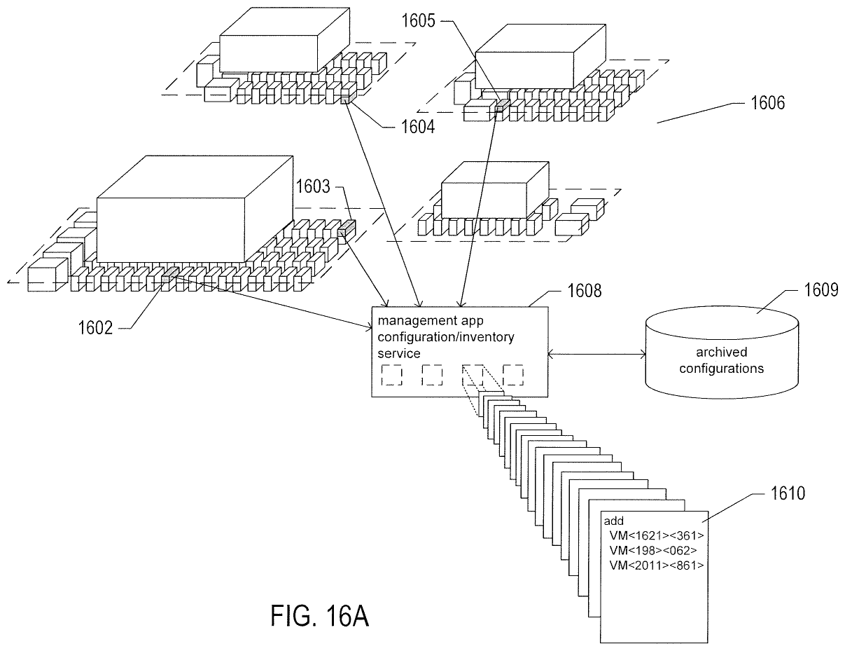

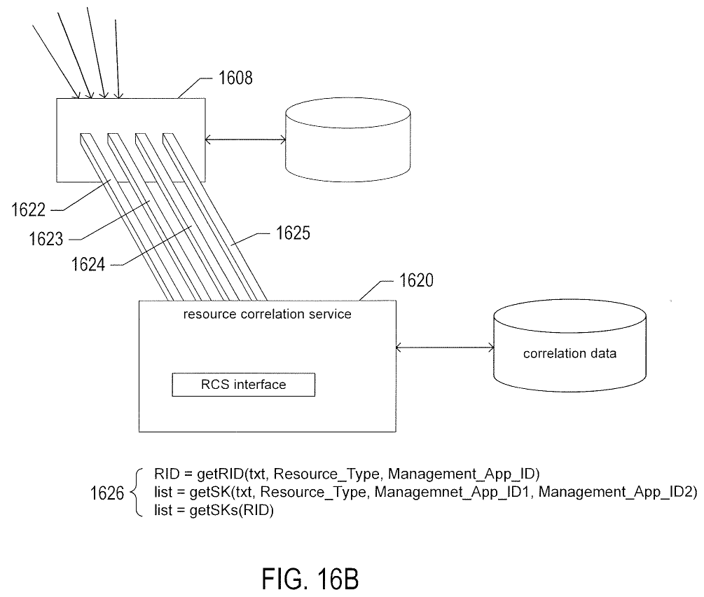

FIGS. 16A-B illustrate one implementation of the currently disclosed resource-identifier-correlation service and/or application. As shown in FIG. 16A, multiple different management services and/or applications 1602-1605 concurrently manage resources within a distributed cloud-computing facility 1606. Although shown as executing on particular servers, these different management services and/or applications may, in fact, be themselves distributed across multiple servers and data centers. The four different management services and/or applications continuously stream configuration and inventory data to a management-application configuration/inventory service 1608. This allows the management-application configuration/inventory service to maintain stored data 1609 representing the computational resources and configurations managed by the different management services and/or applications. The management-application configuration/inventory service then streams computational-resource changes, for each different management service and/or application, to authorized and authenticated computational entities which register to receive the computational-resource changes. In one implementation, the computational entities may register to receive a data stream of computational-resource changes for a particular management service and/or application and then receive an initial set of changes that allow the computational entity to acquire a current computational-resource inventory for the management service and/or application followed by a stream of changes that reflect ongoing changes to the inventory. The computational-resource changes are included in streamed change messages, such as change message 1610, that each includes one or more add, delete, or update changes, each referring to a particular computational resource. For simplicity of explanation, the current discussion assumes that each update change includes all of the natural keys and synthetic keys currently used by the management service and/or application for a particular resource.

As shown in FIG. 16B, the currently disclosed resource-correlation service and/or application 1620 registers for, and receives from, the management application configuration/inventory service 1608 change-message streams 1622-1625 for the various different management services and/or applications within a cloud-computing facility for which resource-identity correlations are desired by clients of the resource-correlation service and/or application. The resource-correlation service and/or application 1620 provides a service interface and/or API 1622 to authorized and authenticated services and applications, but not to human users. Security concerns dictate that resource-correlation information only be provided to services and application, such as the above-discussed universal query adapter, that use the information securely to provide services to authorized and authenticated clients. The service interface and/or API provided by the resource-correlation service and/or application may include a wide variety of different types of functionalities that can be represented by functions, such as the three functions 1626 shown in FIG. 16B. For example, the function getRID( ) receives, as arguments, a synthetic-key value, txt, an indication of a type of computational resource, Resource_Type, and a management-service-and/or-application identifier, Management_App_ID, and returns a universal resource identifier, RID, generated by the resource-correlation service and/or application for the computational resource identified by the synthetic-key value txt. The function getSK( ) receives, as arguments, a synthetic-key value, txt, an indication of a type of computational resource, Resource_Type, a first management-service-and/or-application identifier, Management_App_ID1, for the management service and/or application that identifies a computational resource by the synthetic-key value txt, and a second management-service-and/or-application identifier, Management_App_ID2 and returns a list of the synthetic keys used by the management service and/or application identified by Management_App_ID2 for the computational resource. The function getSKs( ) receives, as arguments, a universal resource identifier, RID, and returns a list of all of the synthetic-key/management-service-and/or-application-identifier pairs representing the synthetic keys used by the various different management services and/or applications to identify the computational resource corresponding to the universal resource identifier. These are but a few examples of many different possible resource-identifier-correlation-related functions that can be provided to computational-entity users by the resource-identifier correlation service and/or application. For example, additional routines may allow lookup of computational resources via natural keys and block-mode requests in which lists of input values are processed to produce corresponding lists of output values. In general, the routines provided by the service interface and/or API of the resource-correlation service and/or application are concerned with correlations between synthetic keys generated and used by management services and/or applications. The resource-correlation service and/or application uses natural keys to uniquely identify the computational resources to which synthetic keys refer when correlations are established. In certain implementations, the routines can also return natural keys that identify a computational resource identified by a particular synthetic key.

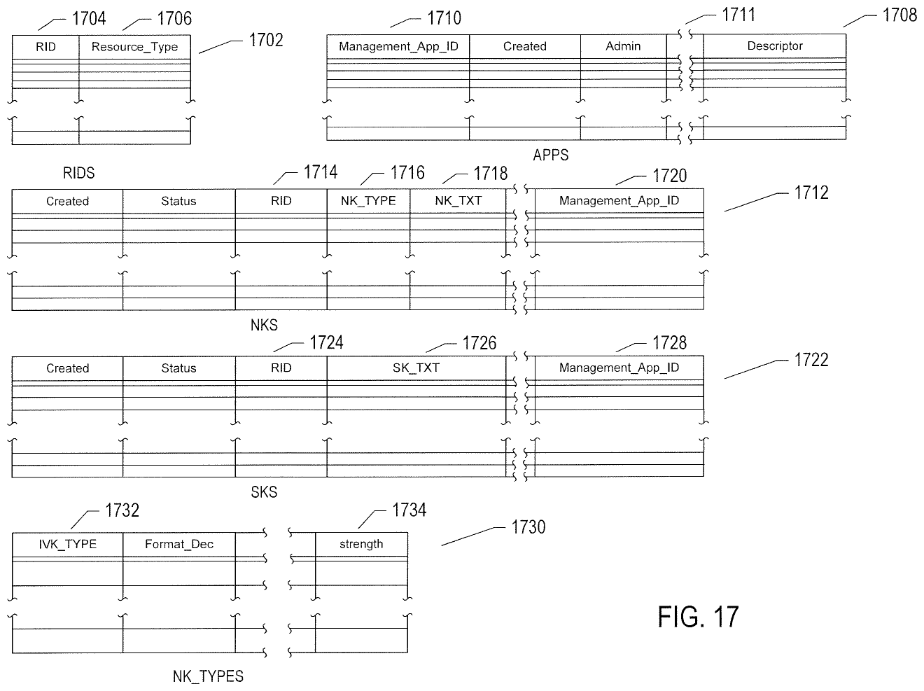

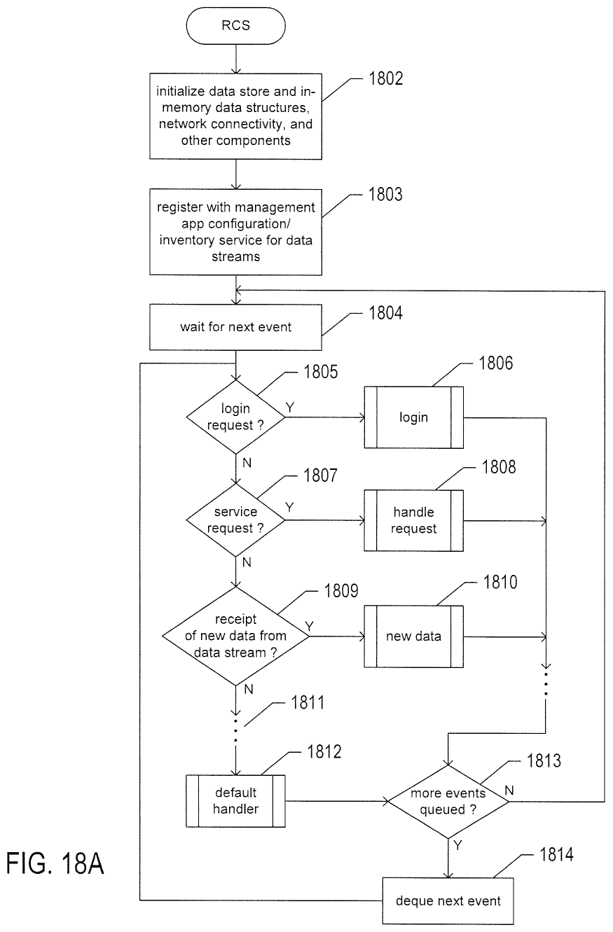

FIG. 17 illustrates five relational-database tables used to illustrate one implementation of the current disclosed resource-identifier-correlation service and/or application. Each row in the table RIDS 1702 includes the value for a field RID, a universal resource identifier, and a value for a field Resource_Type, an indication of the type of computational resource identified by the universal resource identifier. These fields correspond to the columns RID 1704 and Resource_Type 1706. Each row in the table RIDS represents a universal resource identifier that identifies a computational resource for which various different synthetic keys stored in the table SKS, discussed below, may be correlated. In essence, the entries in the table RIDS corresponds to a computational resource for which different synthetic keys may be correlated.

Each row in the table APPS 1708 represents a different management service and/or application that is identified by the value in the field Management_App_ID corresponding to the column 1710 of the same name. The remaining columns in the table APPS contain additional information about the management services or applications represented by the rows in the table APPS. The broken column 1710 represents the possible presence of additional columns in the table, and this illustration convention is used for the remaining tables in FIG. 17. The table APPS is included for completeness. An additional table RTS with entries representing different types of computational resources, would also be included in the database, but is not shown in FIG. 17.

Each row in the table NKS 1712 represents a natural key associated with a particular management service and/or application and a particular universal resource identifier, indications of which are contained in the row. All of the rows in the table NKS containing a particular universal resource identifier represent natural-key/management-service-and/or-application pairs associated with the computational resource identified by the particular universal resource identifier. The column RID 1714 corresponds to fields in the rows containing universal resource identifiers, the column NK_TYPE 1716 corresponds to fields in the rows containing indications of the type of natural key, the column NK_TXT 1718 corresponds to fields in the rows containing natural-key values, and the column Management_App_ID 1720 corresponds to fields in the rows containing identifiers for management services and/or applications. Additional columns in the table NKS contain additional information about the natural-key/management-service-and/or-application pairs. Entries in the table NKS containing universal resource identifiers that also reside in the table RIDS represent natural keys associated with valid synthetic-key correlations. Entries in the table NKS containing universal resource identifiers that do not occur in the table RIDS represent natural keys associated with invalid change operations received in change messages from the management application configuration/inventory service. This data is preserved to enable the invalid change operations to be handled by a database-monitoring routine.

The table SKS 1722 contains entries for synthetic keys. The column RID 1724 corresponds to fields of rows containing a universal resource identifier, the column SK TXT 1726 corresponds to a fields of rows containing natural-key values, and the column Management_App_ID 1728 corresponds to fields of rows containing identifiers for a management service and/or application. As with the table NKS, only those rows, or entries, in the table SKS containing universal resource identifiers that also occur in the table RIDS represent valid correlations. Those entries in the table SKS containing universal resource identifiers that do not occur in the table RIDS represent synthetic keys associated with invalid change operations received in change messages from the management application configuration/inventory service. This data is preserved to enable the invalid change operations to be handled by a database-monitoring routine. The currently disclosed resource-correlation service and/or application provides information about correlations between synthetic keys generated and used by the various different management services and/or applications. The natural keys are used to uniquely determine the identities of computational resources that are, in turn, identified by synthetic keys.

The table NK_TYPES 1730 contains information about natural-key types. The column NK_TYPE 1732 corresponds to fields of rows containing identifiers for natural-key types and the column Strength 1734 contains indications of the strengths of the natural key types, where the strength may be “strong” or “weak.”

There are, of course, a large number of different ways and approaches for representing resource-identifier correlations in stored data. Certain approaches may exclusively use relational-database tables and relational-database queries. Other approaches may use complex data structures that are stored in memory or partially in memory and in mass-storage devices. Still other approaches may use formatted files for storing resource-identifier correlations

One of the most significant features of the data used to represent resource-identifier correlations is the fact that the data is maintained in an entirely consistent state. Thus, when a representation for a new computational resource associated with natural-key values that conflict with the natural-key values associated with a computational resource already represented in the resource-identifier-correlations data is attempted to be added to the database, the new computational resource may be added with an indication that it is in conflict, so that no correlations are returned for the computational resource until the conflict is removed, or may not be added, in the case that the conflicts appear to be serious, as further discussed below. Thus, the resource-identifier-correlation service or application always returns valid correlations, even though, by doing so, certain resources managed by, or known to, one or more management services and/or applications may not be considered when executing correlation queries.

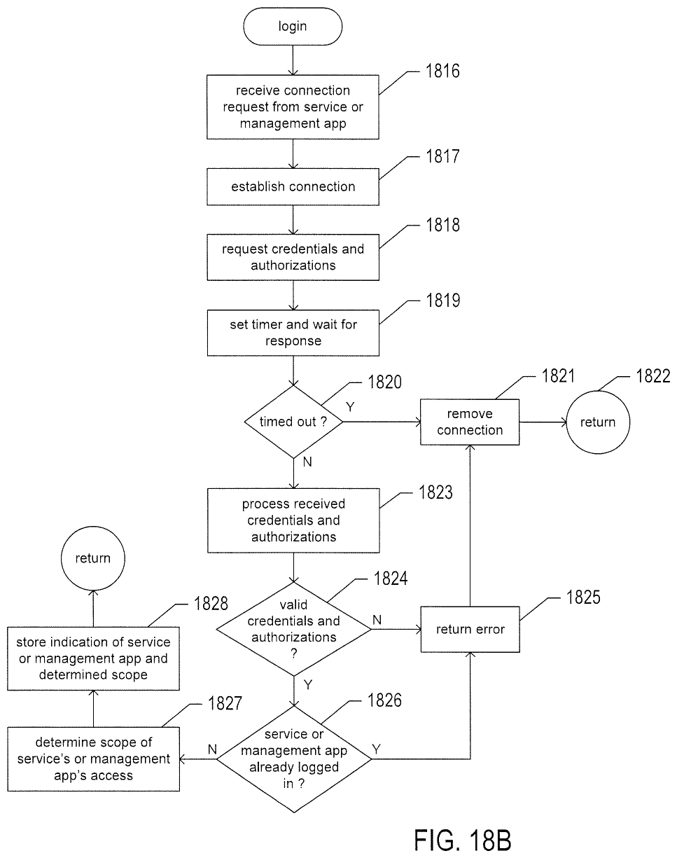

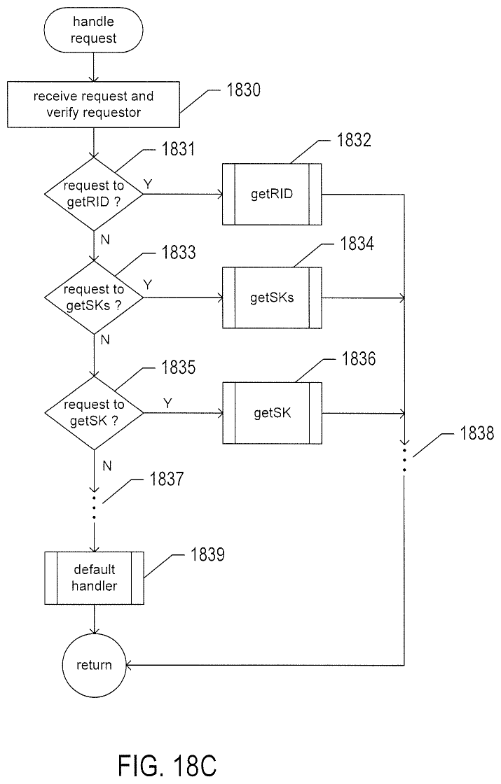

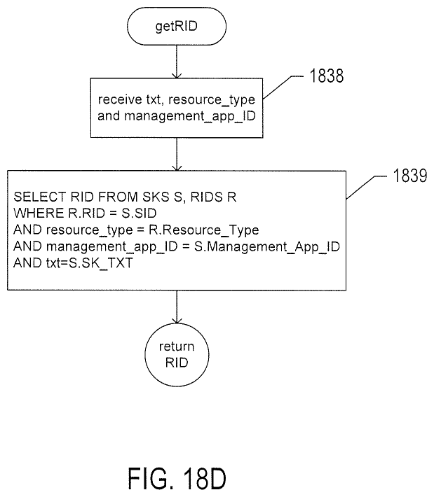

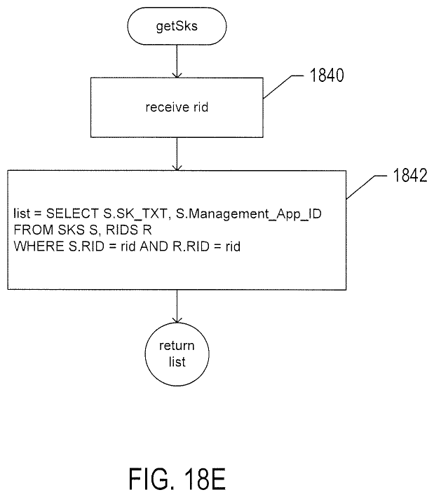

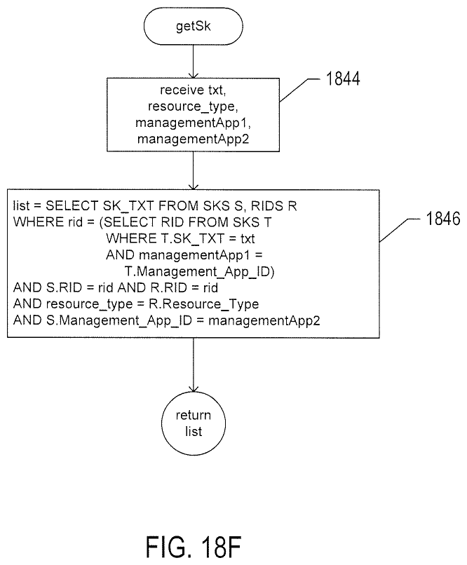

FIGS. 18A-F provide control-flow diagrams that illustrate operation of the currently disclosed resource-identifier-correlation service. FIG. 18A provides a control-flow diagram for an underlying event loop in which the resource-identifier-correlation service handles the various events associated with fielding requests from clients and processing change messages received from the management-application configuration/inventory service, discussed above with reference to FIGS. 16A-B. In step 1802, the resource-identifier-correlation service is launched and initializes the data store, or database, in-memory data structures, network connectivity, and other such components of the resource-identifier-correlation service. In step 1803, the resource-identifier-correlation service registers with the management-application configuration/inventory service to receive change-message streams for each of the various different management services and/or applications with respect to which resource-identifier correlations are to be managed. Then, in step 1804, the resource-identifier-correlation service waits for a next event. When the next event is a login request, as determined in step 18, a login-request handler is called in step 1806. When the next event is reception of a service request, as determined in step 1807, a service-request handler is called in step 1808. When the next event is receipt of a change message via one of the data streams, as detected in step 1809, a new-data handler is called, in step 1810. Ellipses 1811 indicate that many additional types of events may be handled by the resource-identifier-correlation service. For example, timer expirations may result in the resource-identifier-correlation service calling a database-monitoring routine to carry out various types of maintenance tasks, such as examining the database to find data corresponding to various types of failed change operations, discussed below, and to take the necessary steps to handle the failed change operations. A default handler 1812 handles any rare or unexpected events. After handling each event, the resource-identifier-correlation service determines, in step 1813, whether any additional events have been received, during handling of the most recently handled event, and queued for processing. If so, then the next of these pending events is dequeued, in step 1814, and control returns to step 1805. Otherwise, control returns to step 1804.

FIG. 18B provides a control-flow diagram for the login-event handler, called in step 1806 of FIG. 18A. In step 1816, the login handler receives the connection request from a computational entity that represents a login request. In step 1817, the login-event handler establishes a communication connection with the requesting computational entity. In step 1818, the login handler requests needed credentials and authorizations from the computational entity. In step 1819, the login handler sets a timer and waits for a response to the credentials-and-authorizations request. If the timer has timed out, as determined in step 1820, the login handler takes down the connection, in step 1821 and the login handler terminates 1822. Otherwise, in step 1823, the login handler processes the received credentials and authorizations. When the credentials and authorizations are not valid, as determined in step 1824, an error is returned, in step 1825, and control flows to step 1821. Otherwise, in step 1826, the login handler determines whether or not the computational entity is already logged in. If so, then an error is returned in step 1825 and control flows to step 1821. Otherwise, the login handler determines the scope of access that can be offered to the computational entity based on the received credentials and authorizations, in step 1827, and then stores the determined scope for use in servicing subsequent requests from the computational entity, in step 1828.

FIG. 18C provides a control-flow diagram for the request handler, called in step 1808 of FIG. 18A. In step 1830, the request handler receives a request. In step 1831, the request handler determines whether or not the request is for the getRID function. If so, a handler for that function is called in step 1832. Otherwise, in step 1833, the request handler determines whether or not the request is for the function getSKs. If so, then a handler for that function is called in step 1834. Otherwise, in step 1835, the request handler determines whether or not the request is for the function getSK. If so, then a handler for that function is called in step 1836. Ellipses 1837 indicate that many different types of requests may be handled by the request handler. The functions getRID, getSKs, and getSK are used as examples in this illustration. A default handler 1839 handles erroneous or unexpected requests.

FIG. 18D provides a control-flow diagram for the handler for the function getRID, called in step 1832 of FIG. 18C. In step 1838, the getRID handler receives the input synthetic-key value txt, an indication of the type of a computational resource resource_type, and an identifier of a management service and/or application management_app_ID. Step 1839 shows a structured-query-language (“SQL”) query that retrieves a universal resource identifier corresponding to the input synthetic-key value txt and management-service-and/or-application identifier. Of course, additional logic would return a null value were the query to fail to find entries in the tables RIDS and SKS corresponding to the input values and additional logic filters the query results so that only information within the scope of information authorized for return to the requesting user or client is returned by the currently disclosed resource-correlation service and/or application.

FIG. 18E provides a control-flow diagram for the handler for the function “getSKs,” called in step 1834 of FIG. 18C. In step 1842, the getSKs handler receives a universal resource identifier rid. Step 1842 shows an SQL query that retrieves pairs of synthetic-key values and management-service-and/or-application identifiers corresponding to the input universal resource identifier. The assignment to the local variable list indicates that, in the example implementation, the SQL query is embedded in a high-level-the language program that supports list variables and provides an interface for query results to be entered into list variables. Of course, additional logic would return an empty list were the query to fail to find any pairs of synthetic-key values and management-service-and/or-application identifiers and additional logic filters the query results so that only information within the scope of information authorized for return to the requesting user or client is returned by the currently disclosed resource-correlation service and/or application.

FIG. 18F provides a control-flow diagram for the handler for the function “getSK,” called in step 1836 of FIG. 18C. In step 1844, the getSK handler receives the input synthetic-key value txt, an indication of the type of a computational resource resource_type, and two identifiers of management services and/or applications management_app_ID1 and management_app_ID2. Step 1840 shows an SQL query that retrieves synthetic-key values used for the computational resource identified by the input synthetic-key value txt within the management service and/or application identified by the second input identifier management_app_ID2. Of course, additional logic would return an empty list were the query to fail to find any synthetic-key values and additional logic filters the query results so that only information within the scope of information authorized for return to the requesting user or client is returned by the currently disclosed resource-correlation service and/or application.

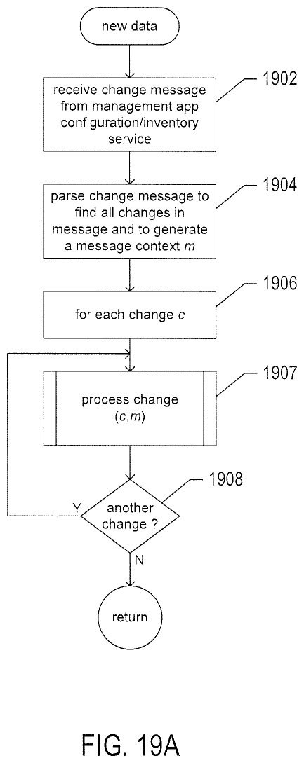

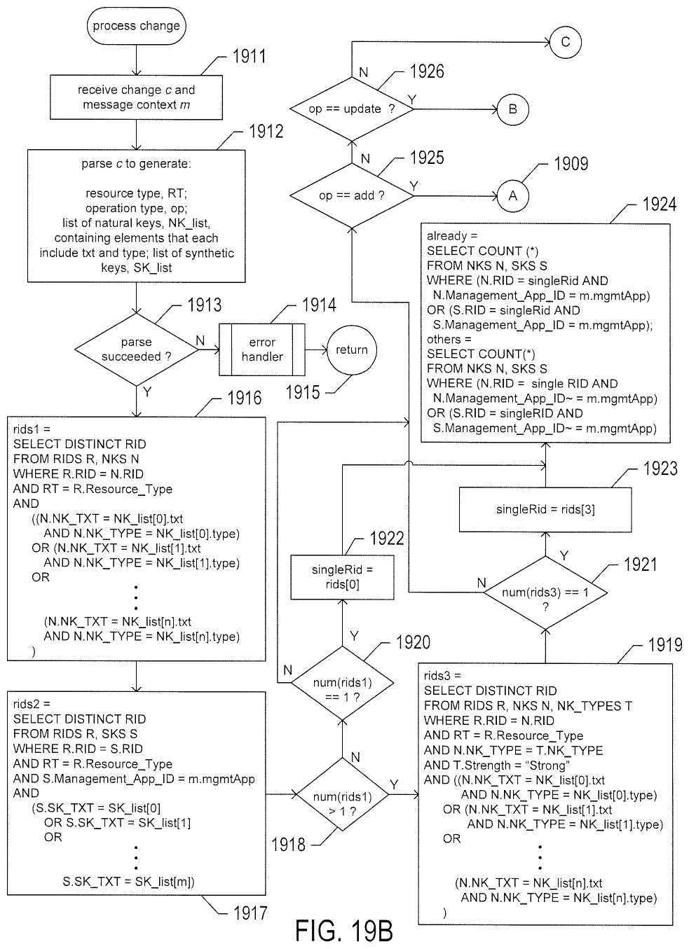

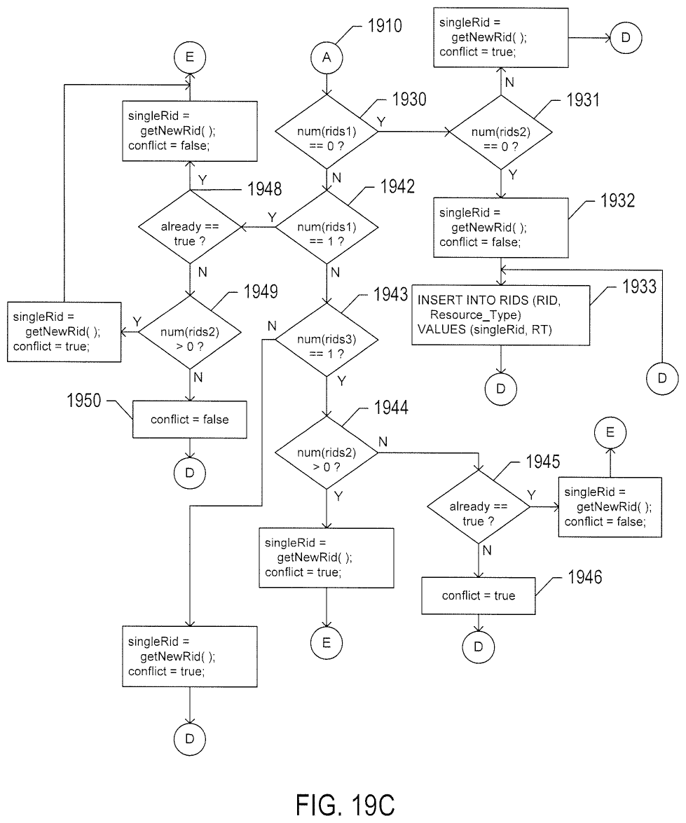

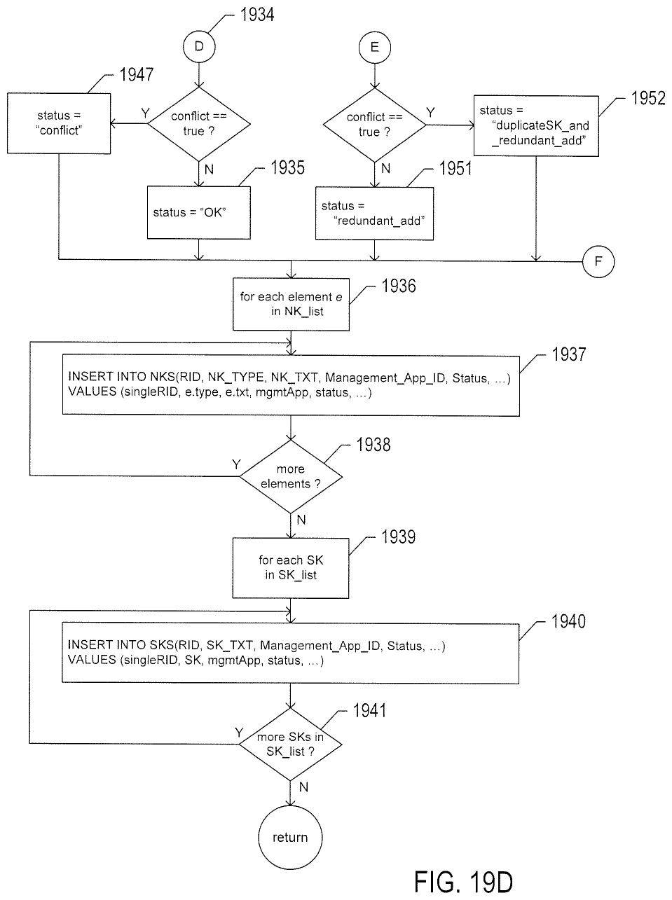

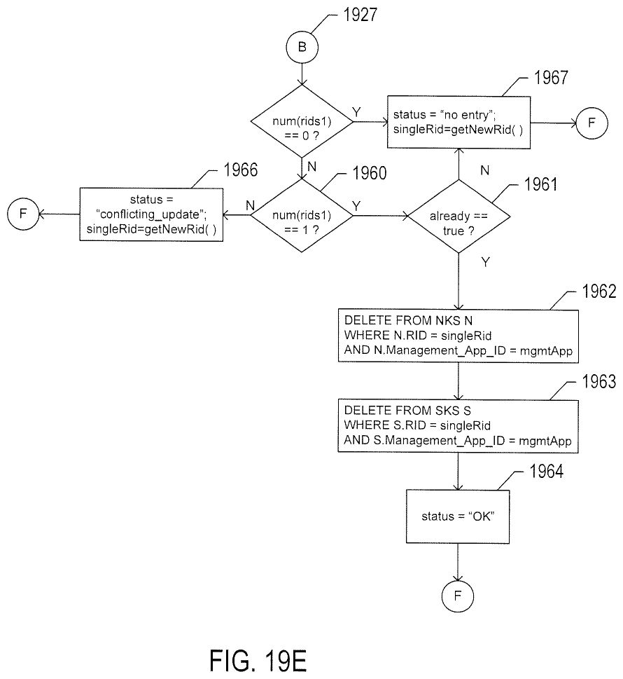

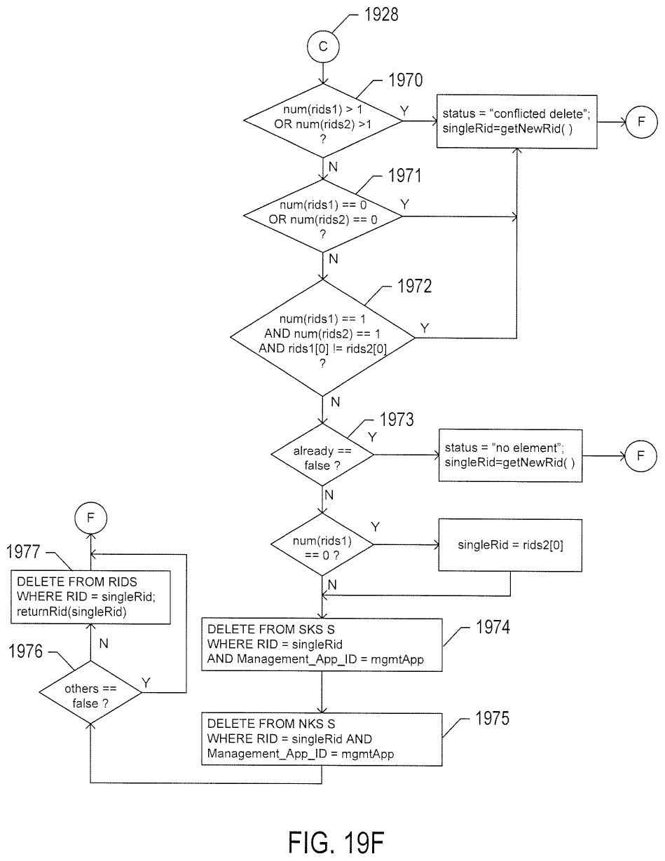

FIGS. 19A-F provide control-flow diagrams for the new-data handler, called in step 1810 of FIG. 18A, that handles change messages received from the management-application configuration/inventory service, as discussed above with reference to FIG. 16A. In step 1902 of FIG. 19A, the new-data handler receives the change message and, in step 1904, parses the change message to find all changes c within the change message and to generate a message context m that contains additional message information, such as an identifier for the management service and/or application from which the message was received. In the for-loop of steps 1906-1908, each change c extracted from the change message is processed via a call to a routine “process change,” which parses and extracts information from the change and then carries out database operations to reflect the change.

FIGS. 19B-F provide control-flow diagrams for the routine “process change,” called in step 1907 of FIG. 19A. These five control-flow diagrams use disc-shaped symbols labeled with single capital letters, such as disc-shaped symbol 1909, to indicate a continuation of the logic to another of the figures at a point where a matching disc-shaped symbol occurs, such as the matching disc-shaped symbol 1910 in FIG. 19C. FIGS. 19B-F use a mixture of SQL statements and high-level-language assignments and logic statements to indicate the logic represented by each step, as in FIGS. 18 D-F, discussed above.

In step 1911 of FIG. 19B, the routine “process change” receives a change c and a message context in extracted from a change message, as discussed above. In step 1912, the routine “process change” parses the change c to extract values that are stored in local variables, including: (1) the type of computational resource related to the change, stored in local variable RT; (2) the type of change operation, stored in local variable op, where the types of change operations include add, update, and delete; (3) a list of natural keys, NK_list, contained in the change, each element in the list including the natural-key value txt and the natural-key type type; and (4) a list of synthetic-key values SK_list. If the parse fails, as determined in step 1913, then an error handler is called, in step 1914, and the routine “process change” returns 1915. Otherwise, the process change generates a number of lists and initializes a local variable in order to prepare to update the correlation database based on the received change c parsed from the change message. The three lists, rids1, rids2, and rids3, contain universal resource identifies associated, in the database, with natural keys, synthetic keys, and only strong natural keys, respectively, included in the change c. While the full contents of these lists are not explicitly used in the described implementation, they may be additionally stored in the database to facilitate handling of invalid change operations by the database-monitoring routine. The local variable singleRid stores the universal resource identifier associated with the natural keys contained in the change c, when only a single universal resource identifier is found.

In step 1916, the routine “process change” generates a first list, rids1, of universal resource identifiers from the database corresponding to the natural-key values extracted from the change c into the natural-key list NK_list. In step 1917, the routine “process change” generates a second list, rids2, of universal resource identifiers from the database corresponding to the synthetic-key values extracted from the change c into the list SK_list. When the number of universal resource identifiers in the list rids1 is greater than 1, as determined in step 1918, then, in step 1919, the routine “process change” generates a third list, rids3, of universal resource identifiers from the database corresponding to the natural-key values extracted from the change c that have natural-key types corresponding to strong natural keys. When the number of universal resource identifiers in the list rids1 is equal to 1, as determined in step 1920, or when the number of universal resource identifiers in the list rids1 is greater than 1 and the number of universal resource identifiers in the list rids3 is equal to 1, as determined in step 1921, the local variable singleRid is set to the single universal resource identifier in the list rids1 or in the list rids3, in steps 1922 or 1923. When adding a new correlation to the database, for example, it is important that the information contained in the corresponding change c for the addition operation refers to, at most, a single universal resource identifier. In the disclosed implementation, when that is not the case for all of the natural-key values contained in the change c, a second attempt is made using only the strong natural-key values, in step 1919. If the second attempt generates only a single universal resource identifier, then a correlation is stored for the change, but the correlation is marked as being in conflict. However, when the second attempt fails, then no correlation is stored, since, as discussed above, the currently disclosed resource-correlation service and/or application maintains only fully consistent correlations between synthetic keys used by different management services and/or application. When the number of universal resource identifiers in the list rids1 is equal to 1, as determined in step 1920, or when the number of universal resource identifiers in the list rids1 is greater than 1 and the number of universal resource identifiers in the list rids3 is equal to 1, as determined in step 1921, the routine “process change,” in step 1924, sets the local variable already to a Boolean value to indicate whether there are any entries in the NKS or SKS tables that include the universal resource identifier stored in the local variable singleRid for the management service and/or application from which the change message was received, therefore indicating whether or not a synthetic key for the computational resource identified by the universal resource identifier in the local variable singleRid has been previously entered into the database by the management service and/or application from which the change message was received. Additionally, the routine “process change,” in step 1924, sets the local variable others to indicate whether there are any entries in the NKS or SKS tables that include the universal resource identifier stored in the local variable singleRid for any management service and/or application other than the management service and/or application from which the change message was received. If the operation corresponding to the message change c is an add operation, as determined in step 1925, control flows to the disc-shaped symbol 1910 in FIG. 19C. If the operation corresponding to the message change c is an update operation, as determined in step 1926, then control flows to the disc-shaped symbol 1927 in FIG. 19E. Otherwise, the operation is a delete operation, and control flows to the disc-shaped symbol 1928 in FIG. 19F.

FIGS. 19C-D include the logic for processing add change operations. There are a variety of different logic paths in FIG. 19C, but only a few correspond to valid add operations. When the information included in the change c, including the natural-key values and synthetic-key values, is not found to correspond to any existing universal resource identifier, as determined in steps 1930 and 1931, the change c it is the first addition of the computational resource to the database, as a result of which a new universal resource identifier is generated and the local variable conflict is set to false, in step 1932, a new entry is added to the table RIDS for the newly generated universal resource identifier, in step 1933, and control flows to the disc-shaped symbol 1934 in FIG. 19D, where the status value “OK” for the new entries to be added to the NKS and SKS tables is stored in the local variable status, in step 1935. Then, in the for-loops of steps 1936-1938 and 1939-1941, entries for each of the natural-key values and synthetic-key values included in the change c are added to the NKS and SKS tables. When multiple universal resource identifiers are identified to be related to the natural-key values in the change c, but, when only strong natural-key values are considered, only a single universal resource identifier is identified, as determined in steps 1930, 1942, and 1943, when no synthetic keys are found in the database to be related to both the identified single universal resource identifier and the management service and/or application from which the change message was received, as determined in step 1944, and when there are no other entries in the database for the universal-resource-identifier/management-service-and/or-application pair, as determined in step 1945, then the local variable conflict is set to true, in step 1946 and control flows to disc-shaped symbol 1934 in FIG. 19D where the value for the status field for the new table entries is set to “conflict,” in step 1947, and new entries for the universal-resource-identifier/management-service-and/or-application are added to the NKS and SKS tables in the for-loops of steps 1936-1938 and 1939-1941. In this case, a correlation based only on strong natural keys is added to the correlation database, but the entries are marked with the status “conflict” to indicate that a conflict was discovered with respect to weak natural keys. When only a single universal-resource identifier is found related to the natural-key values contained in the change c, as determined in step 1942, when there are no entries with respect to the single universal resource in the database for the management service and/or application from which the change message was received, as determined in step 1948, and when there are no synthetic-key identifiers in the database with respect to the universal resource identifier for the management service and/or application from which the change message was received, as determined in step 1949, the local variable conflict is set to false, in step 1950, and control flows to the disc-shaped symbol 1934 in FIG. 19D, where the status is set to “okay” in step 1935 and new entries are added to the NKS and SKS tables in the for-loops of steps 1936-1938 and 1939-1941. All other logic paths in FIG. 19C correspond to invalid add operations, in which case a status value indicating an invalid add operation is set in steps 1947, 1951, or 1952 and new entries are added to the NKS and SKS tables in the for-loops of steps 1936-1938 and 1939-1941. In these cases, there is no corresponding entry in the RIDS table for the universal resource identifiers, as a result of which the entries do not represent correlations, but instead represent failed add operations. As mentioned above, additional information, including the contents of one or more of the lists rdis1, rids2, and rides3 may be added to the database to facilitate analysis of failed add operations.

Thus, in order for an acid operation to succeed, the computational resource that is the subject of the add operation either must not yet have been entered into the database or there are existing entries for the computational resource associated with one or more management services and/or applications other than the management service and/or application from which the change message was received, the natural-key values included in the change c are related only to the universal resource identifier associated with the existing entries for the computational resource, and there are no synthetic keys so far entered in the database for the computational resource associated with the management service and/or application from which the change message was received. In these cases, the database remains consistent, because there are no ambiguities with respect to the computational resources identified by synthetic keys. A conflicted correlation may be added when only weak natural keys collide, as discussed above, but the entries are marked with the status “conflict.” In other cases, no correlation or potential correlation is added, but entries with invalid-add-operation statuses are added to the database to facilitate subsequent handling of the invalid add operations.

FIG. 19E illustrates the logic within the routine “process change” for handling an update operation. When there is a single universal resource identifier related to the information contained in the change c, as determined in step 1960, and when there are entries in the database for this universal resource identifier made on behalf of the management service and/or application from which the change message was received, as determined in step 1961, the current entries made on behalf of the management service and/or application are deleted, in steps 1962-1963, a status of “okay” is stored in the local variable status for inclusion in new entries for the NKS and SKS tables, in step 1964, and control flows to disc-shaped symbol 1965 in FIG. 19D, where the new entries are stored in the NKS and SKS tables. Other cases represent invalid update operations for which error-indicating status values are stored in the local variable status in steps 1966 and 1967 so that the entries for the erroneous update operations are stored in the database with invalid-update-operation statuses.

FIG. 19F illustrates the logic within the routine “process change” for handling a delete operation. When the information contained in the change c it is related to only a single universal resource identifier, as determined in the series of steps 1970-1972, and when there are entries in the database for the management service and/or application which sent the change message, as determined in step 1973, then the entries associated both with the single universal resource identifier and with the management service and/or application from which the change message was received are deleted in steps 1974 and 1975. When there are no other entries related to the universal resource identifier for other management services and/or applications, as determined in step 1976, the universal resource identifier is deleted from the table RIDS in step 1977.

Again, as previously mentioned, the intent of the above-discussed implementation of the currently disclosed resource-identifier-correlation service or application is for the database containing resource-identifier correlations to be entirely consistent. Only those entries in the NKS and SKS tables containing a universal resource identifier that is also contained in the table RIDS represent valid resource-identifier correlation data. All other entries represent data collected from invalid change operations, which are subsequently detected by a database-monitoring routine periodically invoked from the event loop discussed above with reference to FIG. 18A. Various different types of strategies may be employed for handling invalid change operations, from laissez-faire approaches that defer handling for as long as possible in the hope that invalid change operations are subsequently resolved by downstream change operations. to proactive approaches that call error-handling routines for sorting out discrepancies and problems related to the resource-inventory information received from the management-application configuration/inventory service via calls to the management services and/or applications. The entries in the NKS and SKS tables not associated with universal resource identifiers stored within the RIDS table are eventually removed from the database by the database-monitoring routine.

The present invention has been described in terms of particular embodiments, it is not intended that the invention be limited to these embodiments. Modifications within the spirit of the invention will be apparent to those skilled in the art. For example, any of many different implementations of the currently disclosed resource-identifier-correlation service or application can be obtained by varying various design and implementation parameters, including modular organization, control structures, data structures, hardware, operating system, and virtualization layers, and other such design and implementation parameters. As mentioned above, there are many different possible data-storage technologies and approaches, including many different data schemas, that can be used to store the resource-identifier-correlation data. As also mentioned above, the currently disclosed resource-identifier-correlation service or application may provide many different types of functions in the API provided to accessing computational entities related to resource-identifier correlations among multiple management services and/or applications. In the example implementation, add operations add new computational-resource/one-or-more-synthetic-keys/management-service-and/or-application associations to the database, but do not add additional synthetic keys to existing associations, while update operations replace computational-resource/one-or-more-synthetic-keys/management-service-and/or-application associations with altered computational-resource/one-or-more-synthetic-keys/management-service-and/or-application associations. In alternative implementations, the change operations may have different and/or additional functionalities.

1. A resource-identifier correlation system that provides one or both of a resource-identifier-correlation service and a resource-identifier application-program interface to accessing computational entities, the resource-identifier correlation system comprising:
a set of computational entities that include one or more processors, one or more memories, and one or more data-storage devices; and
computer instructions that execute on one or more of the one or more processors and that implement
a first component that
receives data streams containing inventory data for each of multiple management services and/or applications that provide management functionalities with respect to a distributed-computing facility, and
processes the received data streams to generate and maintain stored data that represents correlations between synthetic keys generated and used by the multiple management services and/or applications to identify computational resources in the distributed-computing facility, and
a second component that
receives requests from requesting computational entities,
uses the stored data that represents correlations between the synthetic keys used by the multiple management services and/or applications to generate responses to the requests, and
transmits the responses to the requesting computational entities.

2. The resource-identifier correlation system of claim 1 wherein the requests received by the second component include requests for
a universal resource identifier corresponding to a particular synthetic key;
the synthetic keys used by the multiple management services and/or applications to identify a particular computational resource; and
one or more synthetic keys used by a second management service and/or application to refer to a computational resource identified by a synthetic key used by a first management service and/or application to refer to the computational resource.

3. The resource-identifier correlation system of claim 1 wherein the resource-identifier correlation system uses natural keys generated for computational resources by entities external to the multiple management services and/or applications to identify computational resources, the natural keys including strong natural keys and weak natural keys.

4. The resource-identifier correlation system of claim 3 wherein a strong natural keys uniquely identifies a computational resource within the distributed-computing facility.

5. The resource-identifier correlation system of claim 3 wherein a weak natural key may uniquely identify a computational resource within only a local computing environment, at certain times, within the distributed-computing facility.

6. The resource-identifier correlation system of claim 5 wherein a key that uniquely identifies a computational resource only within a local computing environment within the distributed computing facility is transformed into a natural key by augmenting the resource identifier with additional identifiers, so that the augmented key uniquely identifies the computational resource within the distributed computing facility.

8. The resource-identifier correlation system of claim 1 wherein computational resources include:
virtual machines;
virtual storage devices;
virtual networks;
physical computer systems;
components of physical computer systems;
physical networks;
physical storage devices;
application instances;
network connection endpoints; and
virtual networks.

9. The resource-identifier correlation system of claim 1 wherein the first component processes the received data streams by:
extracting change operations from the received data streams, each change operation associated with a management service and/or application; and
for each extracted change operation,
determining the type of the change operation,
verifying the change operation for validity, and
when the change operation is valid,
updating the stored data that represents correlations between synthetic keys.

10. The resource-identifier correlation system of claim 9 wherein change operations include:
an add operation;
an update operation; and
a delete operation.

11. The resource-identifier correlation system of claim 9 wherein the add operation adds a computational-resource/one-or-more-synthetic-keys/management-service-and/or-application association to the stored data, when the stored data does not contain such an association for the computational resource and the management service and/or application associated with the add operation.

12. The resource-identifier correlation system of claim 11 wherein the add operation is invalid when the stored data already contains a computational-resource/one-or-more-synthetic-keys/management-service-and/or-application association for the computational resource and the management service and/or application associated with the add operation or when the add operation does not contain sufficient information to uniquely identify the computational-resource.

13. The resource-identifier correlation system of claim 9 wherein the update operation alters a computational-resource/one-or-more-synthetic-keys/management-service-and/or-application association to the stored data, when the stored data contains such an association for the computational resource and the management service and/or application associated with the update operation.

14. The resource-identifier correlation system of claim 13 wherein the update operation is invalid when the stored data does not already contain a computational-resource/synthetic-key/management-service-and/or-application association for the computational resource and the management service and/or application associated with the update operation or when the update operation does not contain sufficient information to uniquely identify the computational-resource.

15. The resource-identifier correlation system of claim 9 wherein the delete operation removes a computational-resource/one-or-more-synthetic-keys/management-service-and/or-application association to the stored data, when the stored data contains such an association for the computational resource and the management service and/or application associated with the delete operation.

16. The resource-identifier correlation system of claim 15 wherein the delete operation is invalid when the stored data does not contain a computational-resource/synthetic-key/management-service-and/or-application association for the computational resource and the management service and/or application associated with the delete operation or when the delete operation does not contain sufficient information to uniquely identify the computational-resource.

17. A method for identifying correlations between synthetic keys generated and used by multiple management services and/or applications to identify computational resources within a distributed computing facility, the method comprising:
receiving, by a first component of a resource-identifier-correlation service, data streams containing inventory data for each of the multiple management services and/or applications that provide management functionalities with respect to a distributed-computing facility;
processing, by the first component of a resource-identifier-correlation service, the received data streams to generate and maintain stored data that represents correlations between synthetic keys generated and used by the multiple management services and/or applications to identify computational resources in the distributed-computing facility;
receiving, by a second component of a resource-identifier-correlation service, requests from requesting computational entities,
using, by the second component of a resource-identifier-correlation service, the stored data that represents correlations between the synthetic keys used by the multiple management services and/or applications to generate responses to the requests, and
transmitting, by the second component of a resource-identifier-correlation service, the responses to the requesting computational entities.

18. The method of claim 17 wherein the requests received by the second component include requests for
a universal resource identifier corresponding to a particular synthetic key;
the synthetic keys used by the multiple management services and/or applications to identify a particular computational resource; and
one or more synthetic keys used by a second management service and/or application to refer to a computational resource identified by a synthetic key used by a first management service and/or application to refer to the computational resource.

19. The method of claim 17 wherein the resource-identifier correlation system uses natural keys generated for computational resources by entities external to the multiple management services and/or applications to identify computational resources, the natural keys including strong natural keys and weak natural keys.

20. A physical data-storage system encoded with computer instructions that, when executed by one or more processors in one or more computer systems, control the one or more computer systems to identify correlations between synthetic keys generated and used by multiple management services and/or applications to identify computational resources within a distributed computing facility by:
receiving, by a first component of a resource-identifier-correlation service, data streams containing inventory data for each of the multiple management services and/or applications that provide management functionalities with respect to a distributed-computing facility;
processing, by the first component of a resource-identifier-correlation service, the received data streams to generate and maintain stored data that represents correlations between synthetic keys generated and used by the multiple management services and/or applications to identify computational resources in the distributed-computing facility;
receiving, by a second component of a resource-identifier-correlation service, requests from requesting computational entities,
using, by the second component of a resource-identifier-correlation service, the stored data that represents correlations between the synthetic keys used by the multiple management services and/or applications to generate responses to the requests, and
transmitting, by the second component of a resource-identifier-correlation service, the responses to the requesting computational entities.
